(19) United States
(12) Patent Application Publication
(10) Pub. No.: US 2026/0269487 A1
(43) Pub. Date: Sep. 10, 2026

(54) APPARATUS, SYSTEM, AND METHOD OF ROTATING A POLARIZATION OF RADIO FREQUENCY (RF) SIGNALS

(71) Applicant: MobilEye Vision Technologies Ltd., Jerusalem (IL)

(72) Inventors: Ofer Markish, Raanana (IL); Reuven Shavit, Pardesia (IL); Naftali Landsberg, Kiryat Ono (IL)

(73) Assignee: MobilEye Vision Technologies Ltd., Jerusalem (IL)

(21) Appl. No.: 19/561,003

(22) Filed: Mar. 9, 2026

Related U.S. Application Data
(60) Provisional application No. 63/769,610, filed on Mar. 10, 2025.

(51) Int. Cl. H01Q 15/24; H01Q 1/32; H01Q 9/04

(52) U.S. Cl. CPC H01Q 15/246; H01Q 1/3233; H01Q 9/0485

(57) ABSTRACT

For example, a polarization rotator may be configured to rotate a polarization of one or more Radio Frequency (RF) signals communicated by one or more antennas via a wireless medium. For example, the polarization rotator may include an input to receive a control signal; and a plurality of polarization-rotator cells switchable between a plurality of predefined states, for example, based on the control signal. For example, the plurality of predefined states may include a no-rotation state and a rotation state. For example, the plurality of polarization-rotator cells may be configured to transfer the RF signals between the one or more antennas and the wireless medium at the no-rotation state, and to transfer the RF signals with a predefined polarization rotation applied to the RF signals at the rotation state.

### CROSS-REFERENCE

This application claims the benefit of and priority from U.S. Provisional Patent Application No. 63/769,610, entitled “APPARATUS, SYSTEM, AND METHOD OF ROTATING A POLARIZATION OF RADIO FREQUENCY (RF) SIGNALS”, filed Mar. 10, 2025, the entire disclosure of which is incorporated herein by reference.

### BACKGROUND

Polarization is a property of a wave, which may define a geometrical orientation of oscillations of the wave.

The polarization of a Radio-Frequency (RF) wave, which is communicated via an antenna, may be determined by one or more polarization settings of the antenna.

Many antennas may be implemented as single-polarization antennas, which may communicate signals at a fixed predefined polarization setting.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a system, in accordance with some demonstrative aspects.

FIG. 11 is a schematic illustration of a switchable patch, in accordance with some demonstrative aspects.

FIG. 12 is a schematic illustration of a switchable patch, in accordance with some demonstrative aspects.

FIG. 13 is a schematic illustration of a switchable patch, in accordance with some demonstrative aspects.

FIG. 14 is a schematic illustration of a switchable patch, in accordance with some demonstrative aspects.

FIG. 15A is a schematic illustration of a polarization-rotator cell, in accordance with some demonstrative aspects.

FIG. 15B is a schematic illustration of a polarization rotation scheme to rotate a polarization of one or more Radio Frequency (RF) signals to be communicated via the polarization-rotator cell of FIG. 15A, in accordance with some demonstrative aspects.

FIG. 16 is a schematic illustration of a switchable patch, in accordance with some demonstrative aspects.

FIG. 17 is a schematic illustration of a system including a polarization rotator, in accordance with some demonstrative aspects.

FIG. 18 is a schematic illustration of a polarization rotator configured to rotate a polarization of RF signals communicated by an antenna array, in accordance with some demonstrative aspects.

FIG. 19 is a schematic illustration of a connection scheme to connect a plurality of switchable patches to an input, in accordance with some demonstrative aspects.

FIG. 20 is a schematic flow chart illustration of a method of rotating a polarization of one or more RF signals, in accordance with some demonstrative aspects.

FIG. 21 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, aspect, or design described herein as “exemplary” or “demonstrative” is not necessarily to be construed as preferred or advantageous over other aspects, aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHZ, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

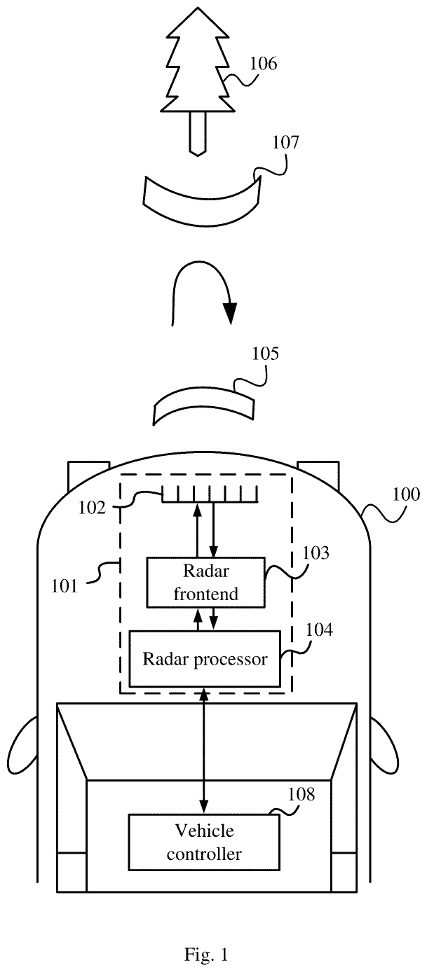

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may be configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identify a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

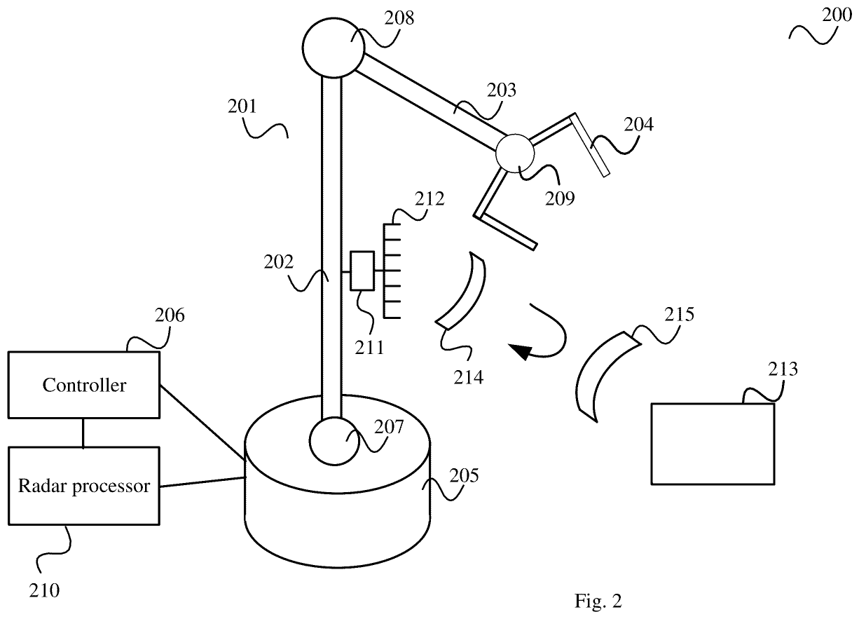

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e., actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

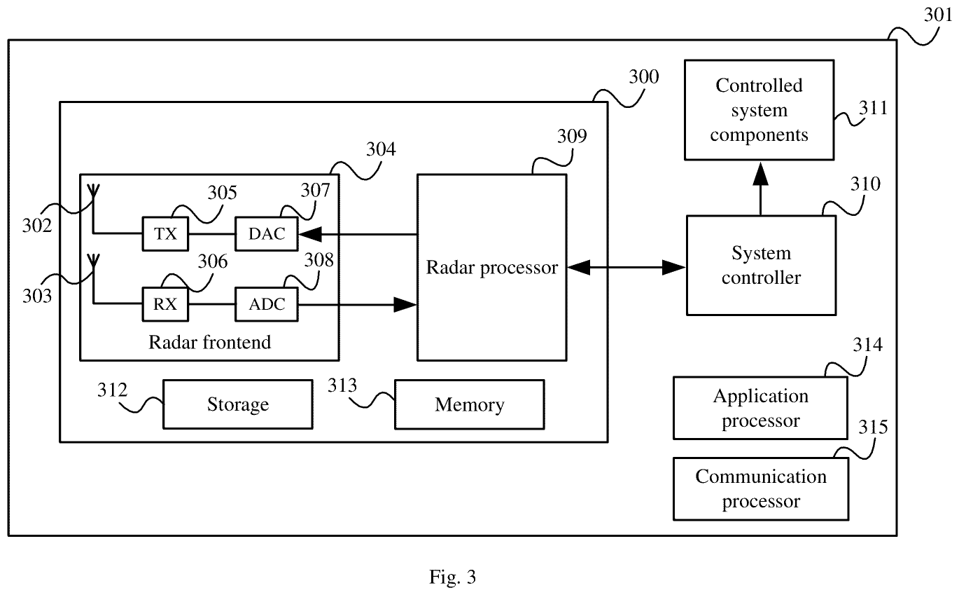

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

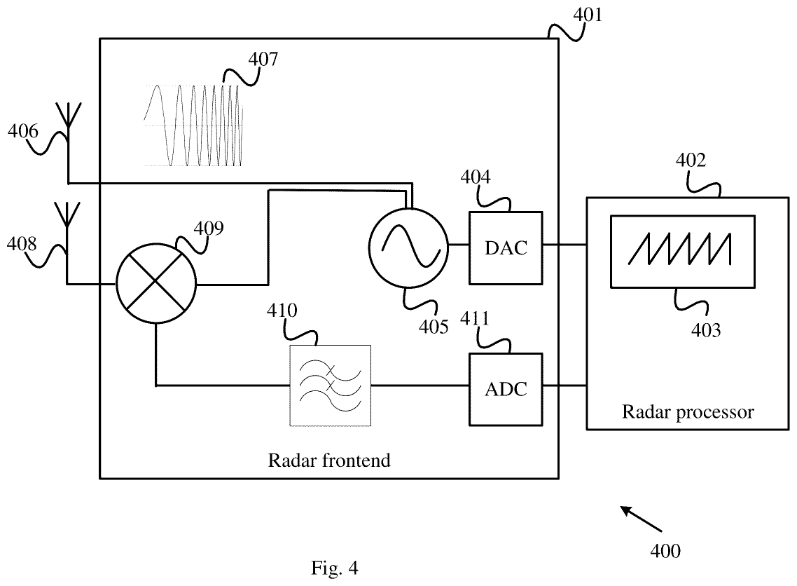

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

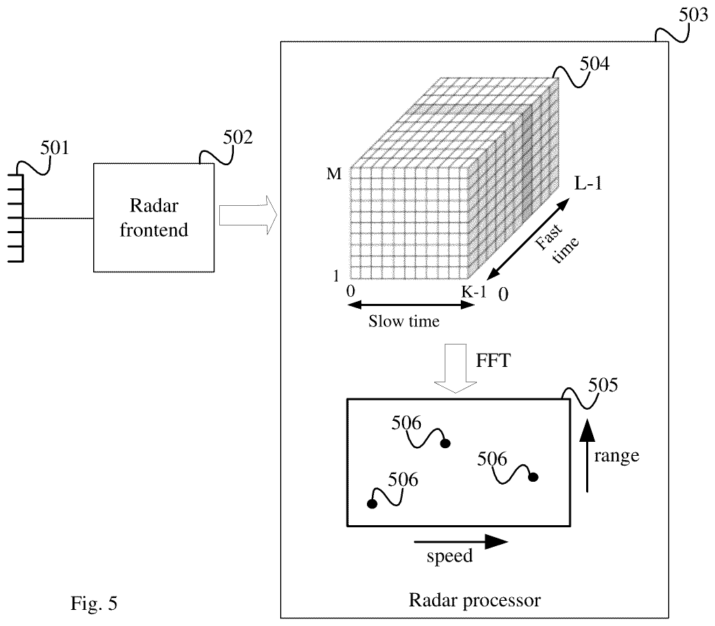

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

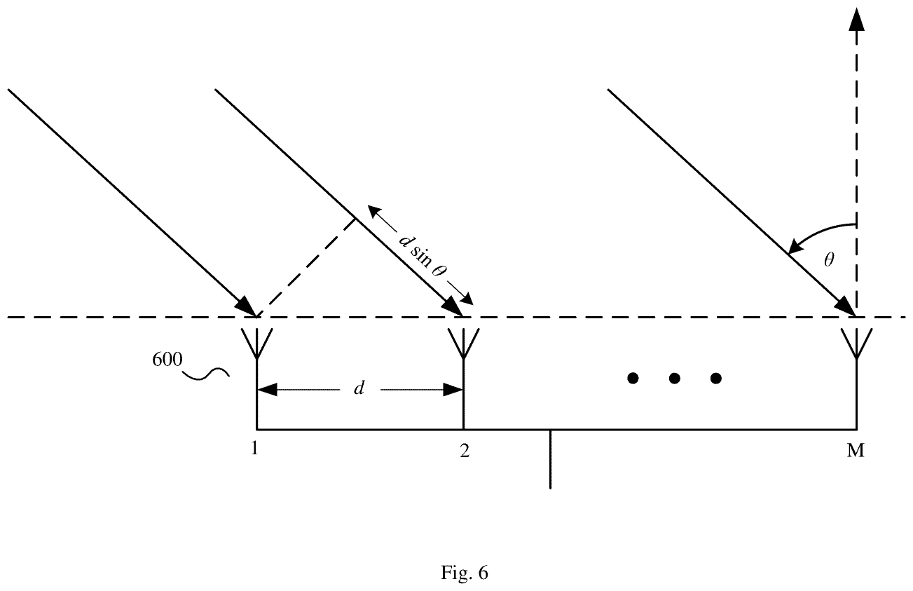

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

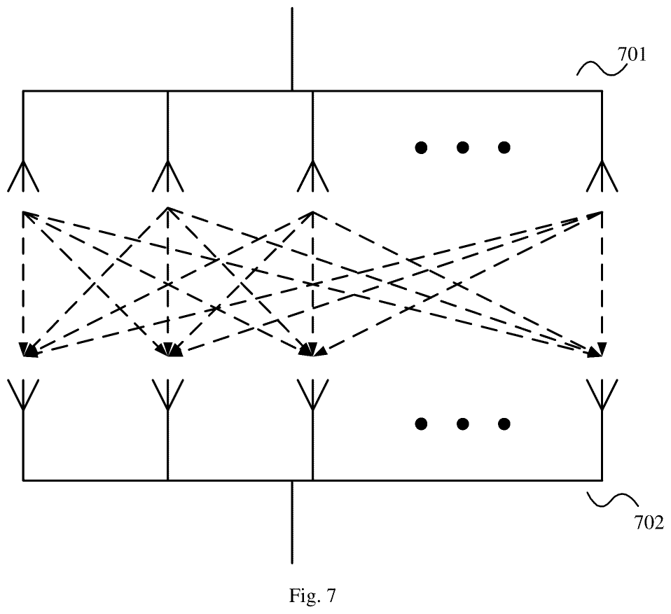

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

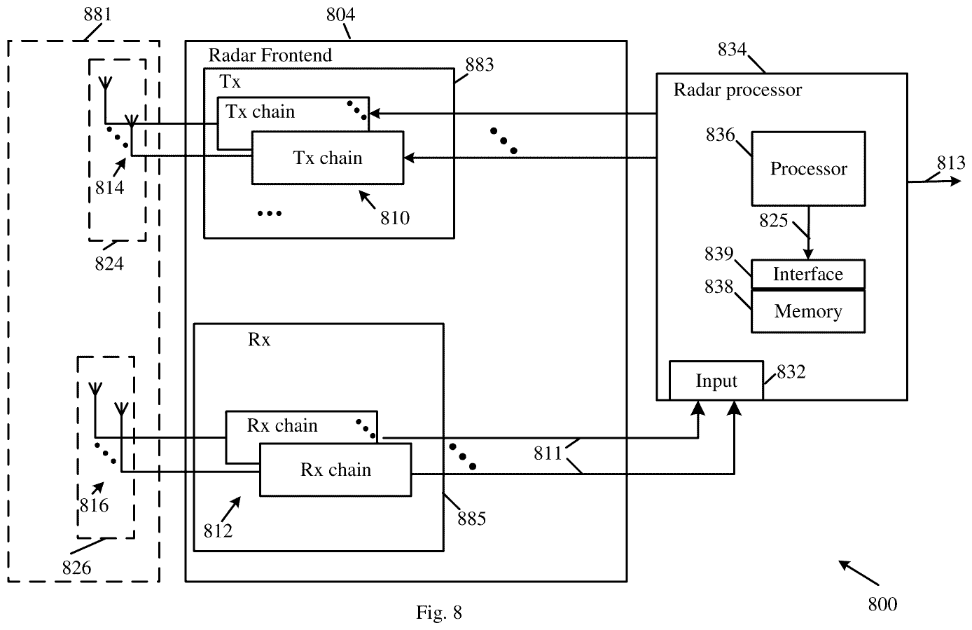

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, Signal to Noise Ratio (SNR) estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

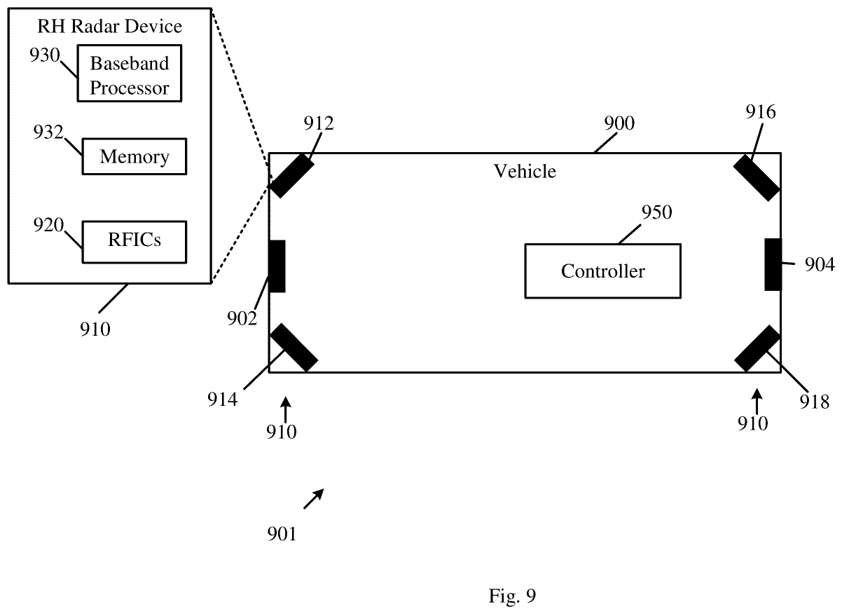

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, a radar device, e.g., as described above with reference to FIGS. 1-9, may include a polarization rotator, which may be configured to rotate a polarization of one or more RF signals communicated by one or more antennas of the radar device via a wireless medium, e.g., as described below.

In some demonstrative aspects, the polarization rotator may be positioned, for example, in front of one or more antennas of the radar device, for example, to rotate the polarization of RF signals transmitted by the one or more antennas, and/or to rotate the polarization of RF signals received by the one or more antennas, e.g., as described below.

In some demonstrative aspects, the polarization rotator may be positioned, for example, between the one or more antennas of the radar device and a radome, e.g., an enclosing radome box, of the radar device, e.g., as described below.

In some demonstrative aspects, the polarization rotator may be configured as an active polarization rotator, which may be configured to actively apply a polarization rotation to the RF signals communicated by the one or more antennas, e.g., as described below.

In some demonstrative aspects, the polarization rotator may be configured to be activated, for example, based on a control signal, e.g., as described below.

In some demonstrative aspects, the polarization rotator may be configured as an active polarization rotator having transparent properties, for example, when the polarization rotator is inactive, e.g., as described below.

In some demonstrative aspects, the polarization rotator may be configured, for example, such that the polarization rotator may be substantially “transparent” to RF signals communicated by the one or more antennas, e.g., in a sense that the polarization rotator may have substantially no effect on the polarization of the RF signals, for example, when the polarization rotator is inactive, e.g., as described below.

In some demonstrative aspects, the polarization rotator may be switchable between a plurality of predefined states, for example, based on a control signal, e.g., as described below.

In some demonstrative aspects, the plurality of predefined states may include, for example, a no-rotation state and a rotation state, e.g., as described below.

In some demonstrative aspects, at the no-rotation state, the polarization rotator may be substantially “transparent” to RF signals communicated by the one or more antennas, e.g., in a sense that the polarization rotator may have substantially no effect on the polarization of the RF signals, e.g., as described below.

In some demonstrative aspects, at the rotation state, the polarization rotator may be active to apply a predefined polarization rotation to the RF signals communicated by the one or more antennas, e.g., as described below.

In some demonstrative aspects, the polarization rotator may be configured to be at an unbiased state, for example, when the polarization rotator is at the no-rotation state, e.g., as described below.

In some demonstrative aspects, the polarization rotator may be configured to be biased, for example, based on the control signal, for example, when the polarization rotator is at the rotation state, e.g., as described below.

In some demonstrative aspects, the polarization rotator may be configured to rotate the polarization of the RF signals communicated by the one or more antennas, for example, using RF switches and/or printed shapes on rotator surfaces of the polarization rotator, e.g., as described below.

In some demonstrative aspects, the polarization rotator may be configured for implementation as an “add-on” polarization rotator, which may be added-on, for example, in front of one or more existing antennas of a radar device, e.g., as described below.

In some demonstrative aspects, the polarization rotator may be configured to provide a technical solution to support implementing a plurality of polarizations for a radar device utilizing one or more single-polarization antennas, e.g., as described below.

In some demonstrative aspects, the polarization rotator may be configured to provide a technical solution to improve performance of a radar device having one or more single-polarization antennas, e.g., as described below.

For example, the polarization rotator may be configured to provide a technical solution to improve target detection, target classification, multipath mitigation, and/or interference mitigation for a radar device having one or more single-polarization antennas, e.g., as described below.

In some demonstrative aspects, the polarization rotator may be configured to provide a technical solution to support a dual-polarization functionality for a radar device having one or more single-polarization antennas, for example, while obviating the implementation of complicated antenna structures and/or an increased number of antenna traces from RFICs to antennas, e.g., which may be required for implementation of dual-polarization antennas, e.g., as described below.

In some demonstrative aspects, the polarization rotator may be configured to provide a technical solution to support a dual-polarization functionality for a radar device, for example, while utilizing existing single-polarization antennas of the radar device. For example, the utilization of the existing single-polarization antennas may provide a technical solution to simplify a manufacturing process and/or to lower cost.

In some demonstrative aspects, the plurality of the predefined states of the polarization rotator may be implemented to provide the dual-polarization functionality for a radar device, for example, by utilizing the no-rotation state of the polarization rotator to support a first polarization state, and utilizing the rotation state of the polarization rotator to support a second polarization state, e.g., as described below.

In some demonstrative aspects, the no-rotation state of the polarization rotator may be utilized to support the first polarization state, for example, at which one or more single-polarization Tx antennas, e.g., all single-polarization Tx antennas, of an antenna array of the radar device and/or one or more single-polarization Rx antennas, e.g., all single-polarization Rx antennas, of the antenna array are utilized to communicate radar RF signals according to a first polarization, e.g., as described below.

For example, the first polarization may include a polarization (original polarization) of the single-polarization Rx antennas and/or the single-polarization Tx antennas.

In some demonstrative aspects, the rotation state of the polarization rotator may be utilized to support the second polarization state, for example, at which one or more single-polarization Tx antennas, e.g., all single-polarization Tx antennas, of the antenna array of the radar device and/or one or more single-polarization Rx antennas, e.g., all single-polarization Rx antennas, of the antenna array are utilized to communicate radar RF signals according to a second polarization, e.g., as described below.

In some demonstrative aspects, the second polarization may be different from the first polarization, e.g., as described below.

In some demonstrative aspects, the second polarization may be substantially orthogonal to the first polarization, e.g., as described below.

In one example, the first polarization may include a horizontal polarization, and the second polarization may include a vertical polarization.

In another example, the first polarization may include a vertical polarization, and the second polarization may include a horizontal polarization.

In another example, the first polarization may include a linear polarization, and the second polarization may include a circular polarization.

In another example, the first polarization may include a circular polarization, and the second polarization may include a linear polarization.

In another example, the first polarization may include a first circular polarization, and the second polarization may include a second circular polarization.

In other aspects, the first polarization and the second polarization may include any other suitable polarizations.

In some demonstrative aspects, the polarization rotator may be configured to provide a technical solution to support implementing a radar device having one or more single-polarization antennas as a dual-polarization radar device, for example, while maintaining a single-polarization antenna design and/or a reduced number of traces of the single-polarization antenna design.

In one example, configuring an antenna to support dual-polarizations may utilize cumbersome structures and/or may require doubling the number of traces from RFICs to the antenna, e.g., compared to the number of traces of a single-polarization antenna.

In some demonstrative aspects, the ability to operate a radar device having one or more single-polarization antennas as a dual-polarization radar device may provide a technical solution to support improved object detection and/or improved classification capabilities of the radar device.

In some demonstrative aspects, the ability to operate a radar device having one or more single-polarization antennas as a dual-polarization radar device may provide a technical solution to support improved performance of the radar device, for example, in multipath scenarios.

In some demonstrative aspects, the ability to operate a radar device having one or more single-polarization antennas as a dual-polarization radar device may provide a technical solution to support improved interference mitigation for the radar device.

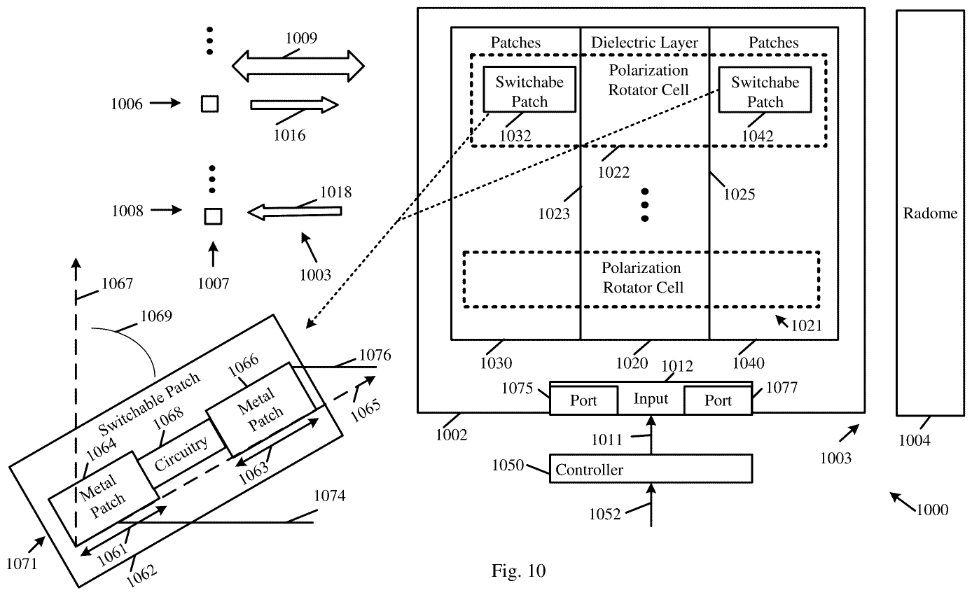

Reference is made to FIG. 10, which schematically illustrates a system 1000, in accordance with some demonstrative aspects.

In some demonstrative aspects, system 1000 may include one or more antennas 1007, e.g., as described below.

In some demonstrative aspects, the one or more antennas 1007 may be configured to communicate one or more RF signals 1009 via a wireless medium 1003, e.g., as described below.

In some demonstrative aspects, system 1000 may include a polarization rotator 1002, which may be configured to rotate a polarization of the one or more RF signals 1009 communicated by the one or more antennas 1007 via the wireless medium 1003, e.g., as described below.

In some demonstrative aspects, polarization rotator 1002 may be configured to rotate the polarization of the one or more RF signals 1009 having a frequency above 70 GHz, e.g., as described below.

In some demonstrative aspects, polarization rotator 1002 may be configured to rotate the polarization of the one or more RF signals 1009 in a frequency band of 76-81 GHz, e.g., as described below.

In some demonstrative aspects, polarization rotator 1002 may be configured to rotate the polarization of the one or more RF signals 1009 having any other additional and/or alternative frequencies.

In some demonstrative aspects, the one or more antennas 1007 may include one or more Tx antennas 1006, which may be configured to transmit one or more Tx signals 1016 via the wireless medium 1003, e.g., as described below.

In some demonstrative aspects, the one or more antennas 1007 may include one or more Rx antennas 1008, which may be configured to receive one or more Rx signals 1018 via the wireless medium 1003, e.g., as described below.

In some demonstrative aspects, polarization rotator 1002 may be configured to rotate a Tx polarization of the one or more Tx signals 1016, which may be transmitted by the one or more Tx antennas 1006 via the wireless medium 1003, e.g., as described below.

In some demonstrative aspects, polarization rotator 1002 may be configured to rotate an Rx polarization of the one or more Rx signals 1018, which may be received by the one or more Rx antennas 1008 via the wireless medium 1003, e.g., as described below.

In some demonstrative aspects, the polarization rotator 1002 may include an input 1012, which may be configured to receive a control signal 1011, e.g., as described below.

In some demonstrative aspects, system 1000 may include a controller 1050, which may be configured to provide the control signal 1011 to the input 1012.

In some demonstrative aspects, controller 1050 may be configured to provide the control signal 1011 to the input 1012, for example, based on a controller input 1052, e.g., as described below. In one example, controller input 1052 may be provided, for example, by a radar controller and/or a system controller, e.g., controller 950 (FIG. 9).

In some demonstrative aspects, the polarization rotator 1002 may include a plurality of polarization-rotator cells 1021, e.g., as described below.

In some demonstrative aspects, the plurality of polarization-rotator cells 1021 may be switchable between a plurality of predefined states, for example, based on the control signal 1011, e.g., as described below.

In some demonstrative aspects, the plurality of predefined states may include a no-rotation state, e.g., as described below.

In some demonstrative aspects, the plurality of predefined states may include a rotation state, e.g., as described below.

In other aspects, the plurality of predefined states may include any other additional and/or alternative states.

In some demonstrative aspects, the plurality of polarization-rotator cells 1021 may be configured to transfer the RF signals 1009 between the one or more antennas 1007 and the wireless medium 1003, for example, at the no-rotation state, e.g., as described below.

In some demonstrative aspects, the plurality of polarization-rotator cells 1021 may be configured to transfer the RF signals 1009 with a predefined polarization rotation applied to the RF signals 1009, for example, at the rotation state, e.g., as described below.

In some demonstrative aspects, the predefined polarization rotation may include a polarization rotation of substantially 90 degrees, e.g., as described below.

In other aspects, the predefined polarization rotation may include any other rotation angle.

In some demonstrative aspects, the predefined polarization rotation may be configured to rotate the polarization of the RF signals 1009 from a first linear polarization to a second linear polarization, e.g., as described below.

In some demonstrative aspects, the predefined polarization rotation may be configured to rotate the polarization of the RF signals 1009 from a first circular polarization to a second circular polarization, e.g., as described below.

In some demonstrative aspects, the predefined polarization rotation may be configured to rotate the polarization of the RF signals 1009 from a circular polarization to a linear polarization, e.g., as described below.

In some demonstrative aspects, the predefined polarization rotation may be configured to rotate the polarization of the RF signals 1009 from a linear polarization to a circular polarization, e.g., as described below.

In other aspects, the predefined polarization rotation may be configured to rotate the polarization of the RF signals 1009 according to any other rotation scheme.

In some demonstrative aspects, the control signal 1011 may include a Direct Current (DC) signal, e.g., as described below.

In other aspects, the control signal 1011 may include any other additional and/or alternative type of signal.

In some demonstrative aspects, the DC signal may include a first voltage level at the no-rotation state, e.g., as described below.

In some demonstrative aspects, the DC signal may include a second voltage level at the rotation state, e.g., as described below.

In some demonstrative aspects, the second voltage level may be different from the first voltage level, e.g., as described below.

In some demonstrative aspects, the first voltage level may be substantially zero, e.g., as described below.

In some demonstrative aspects, the second voltage level may be based, for example, on a voltage supply level (VDD), e.g., as described below.

In other aspects, any other additional and/or alternative voltage levels may be implemented.

In some demonstrative aspects, controller 1050 may be configured to provide the control signal 1011 to control switching of the plurality of polarization-rotator cells 1021 between the plurality of predefined states, for example, based on the controller input 1052, e.g., as described below.

In some demonstrative aspects, the polarization rotator 1002 may include a dielectric layer 1020, e.g., as described below.

In some demonstrative aspects, the polarization rotator 1002 may include a plurality of first switchable patches 1030 on a first surface 1023 of the dielectric layer 1020, e.g., as described below.

In some demonstrative aspects, the polarization rotator 1002 may include a plurality of second switchable patches 1040 on a second surface 1025 of the dielectric layer 1020 opposite to the first surface 1023, e.g., as described below.

In some demonstrative aspects, a polarization-rotator cell 1022 of the plurality of polarization rotator cells 1021 may include a pair of switchable patches including, for example, a first switchable patch 1032 of the plurality of first switchable patches 1030, and a second switchable patch 1042 of the plurality of second switchable patches 1040, e.g., as described below.

In some demonstrative aspects, a switchable patch 1062, e.g., a switchable patch of the plurality of first switchable patches 1030 and/or a switchable patch of the plurality of second switchable patches 1040, may be switchable between a first patch configuration and a second patch configuration, for example, based on the control signal 1011, e.g., as described below.

In some demonstrative aspects, the first patch configuration of switchable patch 1062 may include a plurality of patches, which a may be electrically disconnected from one another, e.g., as described below.

In some demonstrative aspects, the second patch configuration of switchable patch 1062 may include an equivalent patch formed by electric connections between the plurality of patches, e.g., as described below.

In some demonstrative aspects, the switchable patch 1062 may include a plurality of metal patches 1071, e.g., as described below.

In some demonstrative aspects, the plurality of metal patches 1071 may include a first metal patch 1064, e.g., as described below.

In some demonstrative aspects, the plurality of metal patches 1071 may include a second metal patch 1066, e.g., as described below.

In some demonstrative aspects, the switchable patch 1062 may include switching circuitry between the plurality of metal patches 1071, e.g., as described below.

In some demonstrative aspects, the switching circuitry may be configured to electrically disconnect between the plurality of metal patches 1071, for example, at the no-rotation state, e.g., as described below.

In some demonstrative aspects, the switching circuitry 1068 may be configured to electrically connect between plurality of metal patches 1071, for example, at the rotation state, e.g., as described below.

In some demonstrative aspects, the switchable patch 1062 may include switching circuitry 1068, for example, between the first metal patch 1064 and the second metal patch 1066, e.g., as described below.

In some demonstrative aspects, the switching circuitry 1068 may be configured to electrically disconnect between the second metal patch 1066 and the first metal patch 1064, for example, at the no-rotation state, e.g., as described below.

In some demonstrative aspects, the switching circuitry 1068 may be configured to electrically connect between the second metal patch 1066 and the first metal patch 1064, for example, at the rotation state, e.g., as described below.

In some demonstrative aspects, the switching circuitry 1068 may be configured to induce a first impedance between the second metal patch 1066 and the first metal patch 1064, for example, at the no-rotation state, e.g., as described below.

In some demonstrative aspects, the switching circuitry 1068 may be configured to induce a second impedance between the second metal patch 1066 and the first metal patch 1064, for example, at the rotation state, e.g., as described below.

In some demonstrative aspects, the first impedance may be greater than the second impedance, e.g., as described below.

In some demonstrative aspects, the first metal patch 1064 may include a first substantially rectangular metal patch, e.g., as described below.

In some demonstrative aspects, the second metal patch 1066 may include a second substantially rectangular metal patch, e.g., as described below.

In some demonstrative aspects, the first metal patch 1064 and the second metal patch 1066 may be substantially identical, e.g., as described below.

In other aspects, the first metal patch 1064 and the second metal patch 1066 may be configured to have any other suitable, identical or different, shapes.

In some demonstrative aspects, the first metal patch 1064 and the second metal patch 1066 may be positioned side by side along a common axis 1065, e.g., as described below.

In some demonstrative aspects, the common axis 1065 may be rotated by a predefined patch-rotation angle 1069 with respect to a polarization direction 1067 of the polarization of the RF signals 1009, e.g., as described below.

In one example, the polarization direction 1067 may include a vertical direction, e.g., for a vertical polarization of the RF signals 1009.

In another example, the polarization direction 1067 may include a horizontal direction, e.g., for a horizontal polarization of the RF signals 1009.

In some demonstrative aspects, the predefined patch-rotation angle 1069 may be based, for example, on the predefined polarization rotation to be applied by the polarization rotator 1002 at the rotation state, e.g., as described below.

In some demonstrative aspects, an absolute value of the predefined patch-rotation angle 1069 may be substantially 45 degrees, e.g., as described below.

In other aspects, the predefined patch-rotation angle 1069 may have any other suitable value.

In some demonstrative aspects, a sum of lengths of the plurality of metal patches 1071 in the direction along the common axis 1065 may be, for example, equal to or greater than 40% of a wavelength of the RF signals 1009, e.g., as described below.

For example, a sum of a length 1061 of the first metal patch 1064 in the direction along the common axis 1065 and a length 1063 of the second metal patch 1066 in the direction along the common axis 1065 may be, for example, equal to or greater than 40% of the wavelength of the RF signals 1009, e.g., as described below.

In some demonstrative aspects, the sum of the lengths of the plurality of metal patches 1071 in the direction along the common axis 1065 may be, for example, equal to or greater than 50% of the wavelength of the RF signals 1009, e.g., as described below.

For example, the sum of the length 1061 of the first metal patch 1064 and the length 1063 of the second metal patch 1066 may be equal to or greater than half, e.g., 50%, of the wavelength of the RF signals 1009, e.g., as described below.

In some demonstrative aspects, the sum of the lengths of the plurality of metal patches 1071 in the direction along the common axis 1065 may be, for example, substantially half of the wavelength of the RF signals 1009, e.g., as described below.

for example, the sum of the length 1061 of the first metal patch 1064 and the length 1063 of the second metal patch 1066 may be substantially half of the wavelength of the RF signals 1009, e.g., as described below.

In some demonstrative aspects, the sum of the lengths of the plurality of metal patches 1071 in the direction along the common axis 1065 may be, for example, in a range between 40% of the wavelength of the RF signals 1009 and 60% of the wavelength of the RF signals 1009, e.g., as described below.

For example, the sum of the length 1061 of the first metal patch 1064 and the length 1063 of the second metal patch 1066 may be in the range between 40% of the wavelength of the RF signals 1009 and 60% of the wavelength of the RF signals 1009, e.g., as described below.

In some demonstrative aspects, a length of each of the first metal patch 1064 and the second metal patch 1066 in the direction along the common axis 1065, e.g., each of the length 1061 and the length 1063, may be no more than 30% of the wavelength of the RF signals 1009, e.g., as described below.

In some demonstrative aspects, the length of each of the length 1061 and the length 1063 may be no more than a quarter of the wavelength of the RF signals 1009, e.g., as described below.

In some demonstrative aspects, the length of each of the length 1061 and the length 1063 may be substantially equal to a quarter of the wavelength of the RF signals 1009, e.g., as described below.

In some demonstrative aspects, the length of each of the length 1061 and the length 1063 may be in a range between 20% of the wavelength of the RF signals 1009 and 30% of the wavelength of the RF signals 1009, e.g., as described below.

In other aspects, the first metal patch 1064 may have any other length 1061, and/or the second metal patch 1066 may have any other length 1063.

In some demonstrative aspects, the first metal patch 1064 may be connected to a first control line 1074, for example, to electrically connect the first metal patch 1064 to a first control port 1075 of the input 1012, e.g., as described below.

In some demonstrative aspects, the second metal patch 1066 may be connected to a second control line 1076 to electrically connect the second metal patch 1066 to a second control port 1077 of the input 1012, e.g., as described below.

In some demonstrative aspects, the switchable patch 1062 may include one or more first resistors (not shown in FIG. 10) connected between the first metal patch 1064 and the first control line 1074, e.g., as described below.

In some demonstrative aspects, the switchable patch 1062 may include one or more second resistors (not shown in FIG. 10) connected between the second metal patch 1066 and the second control line 1076, e.g., as described below.

In some demonstrative aspects, the switching circuitry 1068 may include a first patch port (not shown in FIG. 10), which may be configured to connect the switching circuitry 1068 to the first metal patch 1064, e.g., as described below.

In some demonstrative aspects, the switching circuitry 1068 may include a second patch port (not shown in FIG. 10), which may be configured to connect the switching circuitry 1068 to the second metal patch 1066, e.g., as described below.

In some demonstrative aspects, the switching circuitry 1068 may include a first control port (not shown in FIG. 10), which may be configured to electrically connect the switching circuitry 1068 to the first control port 1075 of the input 1012, e.g., as described below.

In some demonstrative aspects, the switching circuitry 1068 may include a second control port (not shown in FIG. 10), which may be configured to electrically connect the switching circuitry 1068 to the second control port 1077 of the input 1012, e.g., as described below.

In some demonstrative aspects, the first switchable patch 1032 of the polarization-rotator cell 1022 may be different from the second switchable patch 1042 of the polarization-rotator cell 1022, e.g., as described below.

In some demonstrative aspects, the first switchable patch 1032 may partially overlap with the second switchable patch 1042, e.g., as described below.

In some demonstrative aspects, the first switchable patch 1032 may include a first-switch first metal patch 1064 and a first-switch second metal patch 1066, which may be positioned side by side along a first common axis 1065, e.g., as described below.

In some demonstrative aspects, the second switchable patch 1042 may include a second-switch first metal patch 1064 and a second-switch second metal patch 1066, which may be positioned side by side along a second common axis 1065, e.g., as described below.

In some demonstrative aspects, the second common axis may be rotated with respect to the first common axis, e.g., as described below.

In some demonstrative aspects, an axis-rotation angle (not shown in FIG. 10) between the first common axis and the second common axis may be based, for example, on the predefined polarization rotation, e.g., as described below.

In some demonstrative aspects, the axis-rotation angle between the first common axis and the second common axis may be substantially 90 degrees, e.g., as described below.

In other aspects, any other axis-rotation angle may be implemented between the first common axis and the second common axis.

In some demonstrative aspects, the polarization rotator 1002 may include a plurality of first control lines (not shown in FIG. 10) to electrically connect the first port 1075 of the input 1012 to a plurality of subsets of the plurality of first switchable patches 1030, respectively, e.g., as described below.

In some demonstrative aspects, the polarization rotator 1002 may include a plurality of second control lines (not shown in FIG. 10) to electrically connect the first port 1075 of the input 1012 to a plurality of subsets of the plurality of second switchable patches 1040, respectively, e.g., as described below.

In some demonstrative aspects, the polarization rotator 1002 may include a plurality of third control lines (not shown in FIG. 10) to electrically connect the second port 1077 of the input 1012 to the plurality of subsets of the plurality of first switchable patches 1030, respectively, e.g., as described below.

In some demonstrative aspects, the polarization rotator 1002 may include a plurality of fourth control lines (not shown in FIG. 10) to electrically connect the second port 1077 of the input 1012 to the plurality of subsets of the plurality of second switchable patches 1040, respectively, e.g., as described below.

In some demonstrative aspects, one or more components of system 1000 may be implemented as part of a radar device. For example, radar device 800 (FIG. 8) may include one or more elements of system 1000, and/or may perform one or more operations and/or functionalities of system 1000.

In some demonstrative aspects, the radar device, e.g., radar device 800 (FIG. 8), may include the one or more antennas 1007, and a radome 1004, e.g., as described below.

In some demonstrative aspects, the polarization rotator 1002 may be between the one or more antennas 1007 and the radome 1004, e.g., as described below.

In some demonstrative aspects, the radar device, e.g., radar device 800 (FIG. 8), may include the one or more Tx antennas 1006 to transmit one or more radar Tx signals 1016 with a first polarization via the polarization rotator 1002.

In some demonstrative aspects, the radar device, e.g., radar device 800 (FIG. 8), may include the one or more Rx antennas 1008 to receive one or more radar Rx signals 1018 with the first polarization via the polarization rotator 1002, for example, based on the one or more radar Tx signals 1016, e.g., as described below.

In some demonstrative aspects, the plurality of polarization-rotator cells 1021 may be configured, for example, such that at the rotation state, the plurality of polarization-rotator cells 1021 are to apply the predefined polarization rotation to the one or more radar Tx signals 1016, for example, to rotate the first polarization of the one or more radar Tx signals 1016 to a second polarization, e.g., as described below.

In some demonstrative aspects, the plurality of polarization-rotator cells 1021 may be configured, for example, such that at the rotation state, the plurality of polarization-rotator cells 1021 are to apply the predefined polarization rotation, for example, to rotate a polarization of the one or more radar Rx signals 1018 from the second polarization to the first polarization, e.g., as described below.

In some demonstrative aspects, the plurality of polarization-rotator cells 1021 may be configured, for example, such that at the no-rotation state, the plurality of polarization-rotator cells 1021 are to transfer the one or more radar Tx signals 1016 with the first polarization from the one or more Tx antennas 1006 to the wireless medium 1003, e.g., as described below.

In some demonstrative aspects, the plurality of polarization-rotator cells 1021 may be configured, for example, such that at the no-rotation state, the plurality of polarization-rotator cells 1021 are to transfer the one or more Rx signals 1018 with the first polarization from the wireless medium 1003 to the one or more Rx antennas 1008, e.g., as described below.

In some demonstrative aspects, system 1000 may be implemented as part of any other suitable device and/or system.

For example, in some demonstrative aspects, system 1000 may be implemented as part of a device, for example, a mobile device, a computing device, and/or a wireless communication device, for example, to communicate RF wireless communication signals.

For example, in some demonstrative aspects, system 1000 may be implemented to communicate the RF wireless communication signals over millimeter wave (mmWave) frequencies and/or any other suitable frequencies.

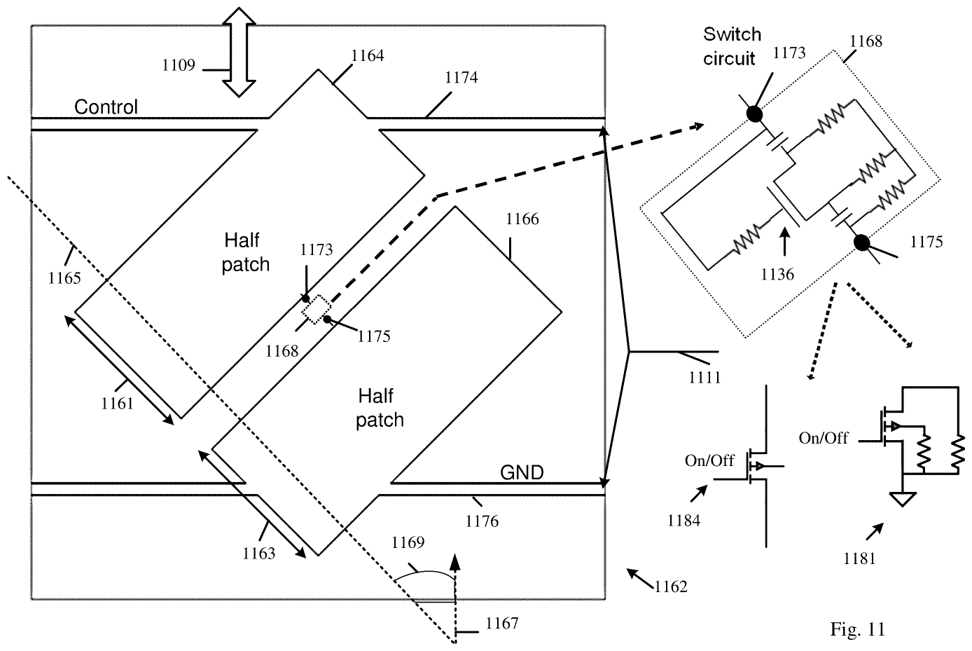

Reference is made to FIG. 11, which schematically illustrates a switchable patch 1162, in accordance with some demonstrative aspects. For example, switchable patch 1062 (FIG. 10) may include one or more elements of switchable patch 1162, and/or may perform one or more operations and/or functionalities of switchable patch 1162.

In some demonstrative aspects, as shown in FIG. 11, the switchable patch 1162 may include a first metal patch 1164.

In some demonstrative aspects, as shown in FIG. 11, the switchable patch 1162 may include a second metal patch 1166.

In some demonstrative aspects, as shown in FIG. 11, the first metal patch 1164 may include a first substantially rectangular metal patch.

In some demonstrative aspects, as shown in FIG. 11, the second metal patch 1166 may include a second substantially rectangular metal patch.

In some demonstrative aspects, as shown in FIG. 11, the first metal patch 1164 and the second metal patch 1166 may be substantially identical.

In some demonstrative aspects, the switchable patch 1162 may be switchable between a first patch configuration and a second patch configuration, for example, based on a control signal 1111.

For example, control signal 1111 may include control signal 1011 (FIG. 10). For example, controller 1050 (FIG. 1) may be configured to control switching of switchable patch 1162 between a first patch configuration and a second patch configuration, for example, according to a state to be configured for a polarization-rotator cell 1022 (FIG. 10) including the switchable patch 1162, e.g., as described above.

For example, switchable patch 1162 may be at the first patch configuration, for example, when the polarization-rotator cell 1022 (FIG. 10) is at the non-rotation state, e.g., as described above.

For example, switchable patch 1162 may be at the second patch configuration, for example, when the polarization-rotator cell 1022 (FIG. 10) is at the rotation state, e.g., as described above.

In some demonstrative aspects, the first patch configuration may include the first metal patch 1164 and the second metal patch 1166 electrically disconnected from one another, e.g., as described below.

In some demonstrative aspects, the second patch configuration may include an equivalent patch formed by electric connection between the first metal patch 1164 and the second metal patch 1166, e.g., as described below.

In some demonstrative aspects, as shown in FIG. 11, the first metal patch 1164 and the second metal patch 1166 may be positioned side by side along a common axis 1165.

In some demonstrative aspects, as shown in FIG. 11, the common axis 1165 may be rotated by a predefined patch-rotation angle 1169 with respect to a polarization direction 1167 of a polarization of RF signals 1109 to be communicated via the switchable patch 1162, e.g., RF signals 1009 (FIG. 10).

In some demonstrative aspects, as shown in FIG. 11, the predefined patch-rotation angle 1169 may be based, for example, on a predefined polarization rotation to be applied by a polarization rotator implementing the switchable patch 1162, e.g., polarization rotator 1002 (FIG. 10), for example, at the rotation state.

In some demonstrative aspects, as shown in FIG. 11, an absolute value of the predefined patch-rotation angle 1169 may be substantially equal to 45 degrees. In other aspects, any other suitable patch-rotation angle 1169 may be implemented, e.g., based on the predefined polarization rotation to be applied to the RF signals 1109 at the rotation state.

In some demonstrative aspects, a sum of a length 1161 of the first metal patch 1164 in a direction along the common axis 1165 and a length 1163 of the second metal patch 1166 in the direction along the common axis 1165 may be equal to or greater than 40% of a wavelength of RF signals 1109.

In some demonstrative aspects, each of the length 1161 and the length 1163 may be no more than 30% of the wavelength of RF signals 1109.

In some demonstrative aspects, each of the length 1161 and the length 1163 may be substantially equal to a quarter of the wavelength of RF signals 1109.

In some demonstrative aspects, as shown in FIG. 11, the switchable patch 1162 may include switching circuitry 1168, for example, between the first metal patch 1164 and the second metal patch 1166.

In some demonstrative aspects, as shown in FIG. 11, the switching circuitry 1168 may be configured to electrically disconnect between the second metal patch 1166 and the first metal patch 1164, for example, at the first patch configuration of the switchable patch 1162, for example, when the polarization-rotator cell 1022 (FIG. 10) is at the no-rotation state, e.g., as described above.

In some demonstrative aspects, as shown in FIG. 11, the switching circuitry 1168 may be configured to electrically connect between the second metal patch 1166 and the first metal patch 1164, for example, at the second patch configuration of the switchable patch 1162, for example, when the polarization-rotator cell 1022 (FIG. 10) is at the rotation state, e.g., as described above.

In some demonstrative aspects, as shown in FIG. 11, the switching circuitry 1168 may be configured to induce a first impedance between the second metal patch 1166 and the first metal patch 1164, for example, at the no-rotation state.

In some demonstrative aspects, as shown in FIG. 11, the switching circuitry 1168 may be configured to induce a second impedance between the second metal patch 1166 and the first metal patch 1164, for example, at the rotation state.

In some demonstrative aspects, the first impedance may be greater than the second impedance.

In some demonstrative aspects, the switching circuitry 1168 may be configured to implement a 2-Port switching scheme utilizing two ports to couple the switching circuitry 1168 to the control signal 1111, for example, via the first metal patch 1164 and the second metal patch 1166, e.g., as described below.

In some demonstrative aspects, as shown in FIG. 11, the first metal patch 1164 may be connected to a first control line 1174, for example, to electrically connect the first metal patch 1164 to a first control port of an input to provide the control signal 1111, e.g., the first control port 1075 (FIG. 10).

In some demonstrative aspects, as shown in FIG. 11, the second metal patch 1166 may be connected to a second control line 1176, for example, to electrically connect the second metal patch 1166 to a second control port of an input to provide the control signal 1111, e.g., the second control port 1077 (FIG. 10).

In some demonstrative aspects, as shown in FIG. 11, the switching circuitry 1168 may include a first patch port 1173, which may be configured to connect the switching circuitry 1168 to the first metal patch 1164.

In some demonstrative aspects, as shown in FIG. 11, the switching circuitry 1168 may include a second patch port 1175, which may be configured to connect the switching circuitry 1168 to the second metal patch 1166.

In some demonstrative aspects, as shown in FIG. 11, the first metal patch 1164 and the second metal patch 1166 may be configured to provide and/or carry control signals 1111 to the switching circuitry 1168.

In some demonstrative aspects, as shown in FIG. 11, a switching functionality of the switching circuitry 1168 may be implemented by one or more transistors 1136.

In other aspects, the switching functionality of switching circuitry 1168 may be implemented by any other additional and/or alternative circuitry.

In one example, the switching functionality of switching circuitry 1168 may be implemented by one or more mechanical switches, e.g., Micro Electro Mechanical System (MEMS), or the like.

In another example, the switching functionality of switching circuitry 1168 may be implemented by one or more diodes, e.g., PiN diodes, or the like.

In some demonstrative aspects, the switching functionality of switching circuitry 1168 may be implemented by one or more transistors 1136, which may be configured, for example, to provide a technical solution to support a low-cost implementation and/or a low-cost process, e.g., a Complementary Metal Oxide Semiconductor (CMOS) process.

In some demonstrative aspects, as shown in FIG. 11, the switching functionality of switching circuitry 1168 may be implemented, for example, utilizing one or more N-channel Metal-Oxide semiconductor (NMOS) transistors 1136.

In some demonstrative aspects, switching circuitry 1168 may be switchable between an “OFF” state and an “ON” state, for example, based on a voltage difference between the first patch port 1173 and the second patch port 1175, e.g., as described below.

In some demonstrative aspects, the voltage difference between the first patch port 1173 and the second patch port 1175 may be controlled, for example, according to a voltage difference between the first control line 1174 and the second control line 1176.

In some demonstrative aspects, the control signal 1111 may be configured, for example, to provide a voltage difference between the first control line 1174 and the second control line 1176, which may be configured, for example, to cause a voltage difference between the first patch port 1173 and the second patch port 1175, which may be sufficient to switch the switching circuitry 1168 from the “OFF” state and an “ON” state, e.g., as described below.

In some demonstrative aspects, as shown in FIG. 11, the first control line 1174 may include a signal control line to provide control signal 1111 to the first patch port 1173, e.g., via the first patch element 1164.

In some demonstrative aspects, as shown in FIG. 11, the second control line 1176 may include a Ground (GND) line to ground the second patch port 1175, e.g., via the second patch element 1166.

In some demonstrative aspects, the control signal 1111 may be configured, for example, to provide a first voltage level between the first control line 1174 and the second control line 1176, which may be configured, for example, to cause a first voltage level between the first patch port 1173 and the second patch port 1175, for example, at the no-rotation state, e.g., of the polarization-rotator cell 1022 (FIG. 10), e.g., as described below.

In some demonstrative aspects, the control signal 1111 may be configured, for example, to provide a second voltage level between the first control line 1174 and the second control line 1176, which may be configured, for example, to cause a second voltage level between the first patch port 1173 and the second patch port 1175, for example, at the rotation state, e.g., of the polarization-rotator cell 1022 (FIG. 10), e.g., as described below.

In some demonstrative aspects, the control signal 1111 may be configured, for example, to provide a zero voltage level between the first patch port 1173 and the second patch port 1175, for example, at the no-rotation state. For example, the control signal 1111 may be configured to apply a zero voltage at the first control line 1174, e.g., at the no-rotation state.

In some demonstrative aspects, the control signal 1111 may be configured, for example, to provide a VDD voltage level between the first patch port 1173 and the second patch port 1175, for example, at the rotation state. For example, the control signal 1111 may be configured to apply the VDD voltage at the first control line 1174, e.g., at the rotation state.

In one example, the first control line 1174 may be utilized as a VDD net, for example, according to an NMOS implementation of transistors 1136. For example, there may be no current flow through the switching circuitry 1168, e.g., at the “OFF” state of the switching circuitry 1168 and, accordingly, an Nwell connection of the switching circuitry 1168 may be provided with an incorrect voltage level. For example, the first control line 1174 may be utilized as the VDD net, for example, to provide an appropriate voltage level to the Nwell connection of the switching circuitry 1168, e.g., at the “ON” state of the switching circuitry 1168.

In some demonstrative aspects, switching circuitry 1168 may be configured to implement the 2-Port switching scheme as an interface to the control input 1111, for example, via the connection of the first metal patch 1164 to the first control line 1174 and the connection of the second metal patch 1166 to the second control line 1176. For example, the 2-Port switching scheme may be implemented, for example, to provide a technical solution to support a low footprint of the switching circuitry 1168 on a board.

In some demonstrative aspects, switching circuitry 1168 may be configured to implement the 2-Port switching scheme, for example, to provide a technical solution to support a reduced, e.g., a minimal, routing of the control signal 1111 on the board, for example, to preserve performance of the switchable patch 1162 and/or performance of a polarization rotator implementing the switchable patch 1162, e.g., polarization rotator 1002 (FIG. 10).

In some demonstrative aspects, the switching circuitry 1168 may include first circuitry components, for example, which may be configured to remove at least part of a DC signal from a signal path of the switching circuitry 1168, for example, to support a proper functionality of at least one switch of the switching circuitry 1168, e.g., transistor 1136.

In some demonstrative aspects, the first circuitry components may include DC blocks, which may be used to remove the DC signal from the signal path.

In some demonstrative aspects, the switching circuitry 1168 may include second circuitry components, which may be configured to remove at least part of an RF signal, which may be induced by the first metal patch 1164 and/or the second metal patch 1166, for example, from the control signal 1111, which is to be provided into the at least one switch of the switching circuitry 1168, e.g., transistor 1136.

In some demonstrative aspects, the second circuitry components may include high impedance resistors and/or inductors, which may be configured to route the control signal 1111 into a gate of the switch 1136, and/or a DC ground connection to the switch 1136, for example, while preventing the RF signal from modulating a gate of the switch 1136.

In some demonstrative aspects, as shown in FIG. 11, components of switching circuitry 1168 may be implemented by equivalent DC switching circuitry 1181. For example, switching circuitry 1181 may be configured to provide a DC equivalent of the components of the switching circuitry 1168, for example, to apply a DC bias to the switch 1136.

In some demonstrative aspects, as shown in FIG. 11, components of switching circuitry 1168 may be implemented by equivalent AC switching circuitry 1184. For example, switching circuitry 1184 may be configured to provide an AC equivalent of the components of the switching circuitry 1168, for example, to provide an AC path between the switching circuitry 1168 and the metal patches 1164 and 1168.

In some demonstrative aspects, switching circuitry, e.g., switching circuitry 1168, may be implemented, for example, utilizing one or more NMOS transistors 1136, e.g., as described above.

In some demonstrative aspects, switching circuitry may be implemented, for example, utilizing one or more P-channel Metal-Oxide Semiconductor (PMOS) transistors, e.g., instead of the one or more NMOS transistors, e.g., as described below.

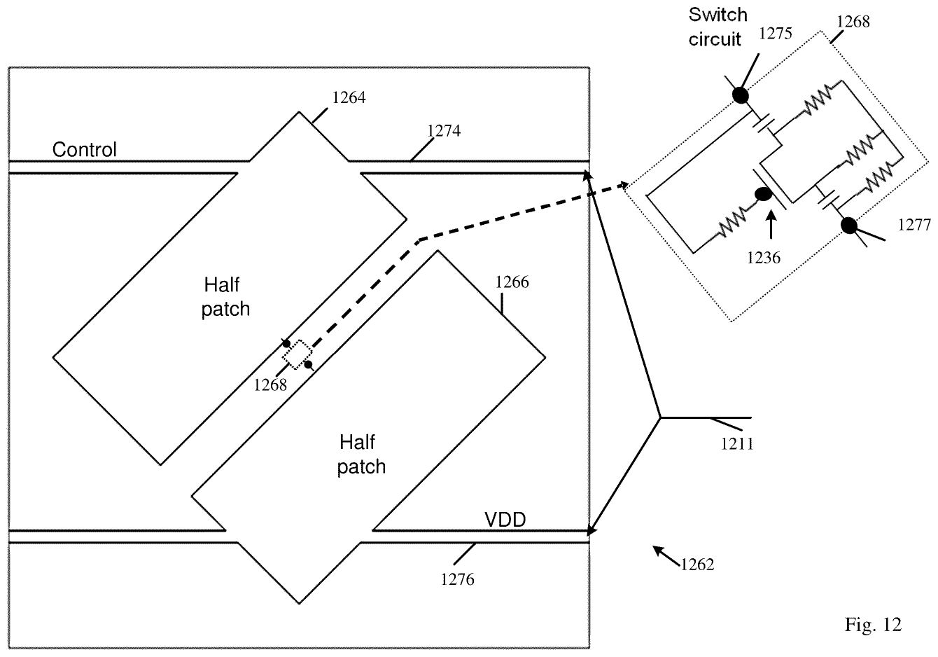

Reference is made to FIG. 12, which schematically illustrates a switchable patch 1262, in accordance with some demonstrative aspects. For example, switchable patch 1062 (FIG. 10) may include one or more elements of switchable patch 1262, and/or may perform one or more operations and/or functionalities of switchable patch 1262.

In some demonstrative aspects, as shown in FIG. 12, the switchable patch 1262 may include a first metal patch 1264.

In some demonstrative aspects, as shown in FIG. 12, the switchable patch 1262 may include a second metal patch 1266.

In some demonstrative aspects, the switchable patch 1262 may be switchable between a first patch configuration and a second patch configuration, for example, based on a control signal 1211.

For example, control signal 1211 may include control signal 1011 (FIG. 10). For example, controller 1050 (FIG. 1) may be configured to control switching of switchable patch 1262 between a first patch configuration and a second patch configuration, for example, according to a state to be configured for a polarization-rotator cell 1022 (FIG. 10) including the switchable patch 1262, e.g., as described above.

For example, switchable patch 1262 may be at the first patch configuration, for example, when the polarization-rotator cell 1022 (FIG. 10) is at the non-rotation state, e.g., as described above.

For example, switchable patch 1262 may be at the second patch configuration, for example, when the polarization-rotator cell 1022 (FIG. 10) is at the rotation state, e.g., as described above.

In some demonstrative aspects, the first patch configuration may include the first metal patch 1264 and the second metal patch 1266 electrically disconnected from one another, e.g., as described below.

In some demonstrative aspects, the second patch configuration may include an equivalent patch formed by electric connection between the first metal patch 1264 and the second metal patch 1266, e.g., as described below.

In some demonstrative aspects, as shown in FIG. 12, the first metal patch 1264 may be connected to a first control line 1274, for example, to electrically connect the first metal patch 1264 to a first control port of an input to provide the control signal 1211, e.g., the first control port 1075 (FIG. 10).

In some demonstrative aspects, as shown in FIG. 12, the second metal patch 1266 may be connected to a second control line 1276, for example, to electrically connect the second metal patch 1166 to a second control port of an input to provide the control signal 1211, e.g., the second control port 1077 (FIG. 10).

In some demonstrative aspects, the switching circuitry 1268 may be configured to implement a 2-Port switching scheme utilizing two ports to couple the switching circuitry 1268 to the control signal 1211, for example, via the first metal patch 1264 and the second metal patch 1266, e.g., as described below.

In some demonstrative aspects, as shown in FIG. 12, a configuration of switchable patch 1262 may be similar to a configuration of switchable patch 1162 (FIG. 11).

In some demonstrative aspects, as shown in FIG. 12, the switching functionality of the switching circuitry 1268 may be implemented, for example, utilizing one or more PMOS transistors 1236, for example, instead of the one or more NMOS transistors 1136 (FIG. 11).

In some demonstrative aspects, the switching circuitry 1268 may be implemented utilizing the one or more PMOS transistors 1236, for example, to provide a technical solution to support cost reduction for manufacturing of the switching circuitry 1268.

In some demonstrative aspects, as shown in FIG. 12, the first control line 1274 may include a signal control line to provide control signal 1211 to the first patch port 1273, e.g., via the first patch element 1264.

In some demonstrative aspects, as shown in FIG. 12, the second control line 1276 may include a VDD line, for example, to provide VDD voltage to the second patch port 1275, e.g., via the second patch element 1266.

In one example, the implementation of control line 1176 (FIG. 11) as a GND line, may be replaced by the implementation of control line 1276 as a VDD line, for example, to support functionality of the one or more PMOS transistors 1236.

In some demonstrative aspects, the control signal 1211 may be configured, for example, to provide a first voltage level between the first control line 1274 and the second control line 1276, which may be configured, for example, to cause a first voltage level between the first patch port 1273 and the second patch port 1275, for example, at the no-rotation state, e.g., of the polarization-rotator cell 1022 (FIG. 10), e.g., as described below.

In some demonstrative aspects, the control signal 1211 may be configured, for example, to provide a second voltage level between the first control line 1274 and the second control line 1276, which may be configured, for example, to cause a second voltage level between the first patch port 1273 and the second patch port 1275, for example, at the rotation state, e.g., of the polarization-rotator cell 1022 (FIG. 10), e.g., as described below.

In some demonstrative aspects, the control signal 1211 may be configured, for example, to provide a zero voltage level between the first patch port 1273 and the second patch port 1275, for example, at the no-rotation state. For example, the control signal 1211 may be configured to apply a VDD voltage at the first control line 1274, e.g., at the no-rotation state.

In some demonstrative aspects, the control signal 1211 may be configured, for example, to provide a VDD voltage level between the first patch port 1273 and the second patch port 1275, for example, at the rotation state. For example, the control signal 1211 may be configured to apply a zero voltage at the first control line 1274, e.g., at the rotation state.

In one example, the first control line 1274 may be utilized as a GND net, for example, according to a PMOS implementation of transistors 1236. For example, there may be no current flow through the switching circuitry 1268, e.g., at the “OFF” state of the switching circuitry 1268 and, accordingly, a Pwell connection of the switching circuitry 1268 may be provided with an incorrect voltage level. For example, the first control line 1274 may be utilized as the GND net, for example, to provide an appropriate voltage level to the Pwell connection of the switching circuitry 1268, e.g., at the “ON” state of the switching circuitry 1268.

In some demonstrative aspects, switching circuitry, e.g., switching circuitry 1168 (FIG. 11) and/or switching circuitry 1268, may be implemented, for example, utilizing a 2-Port switching scheme, e.g., as described above.

In some demonstrative aspects, the 2-Port switching scheme may be replaced by a 4-Port switching scheme, which may utilize two control ports to couple switching circuitry to a control signal via two control lines, and two patch ports to couple the switching to two metal patches, e.g., as described below.

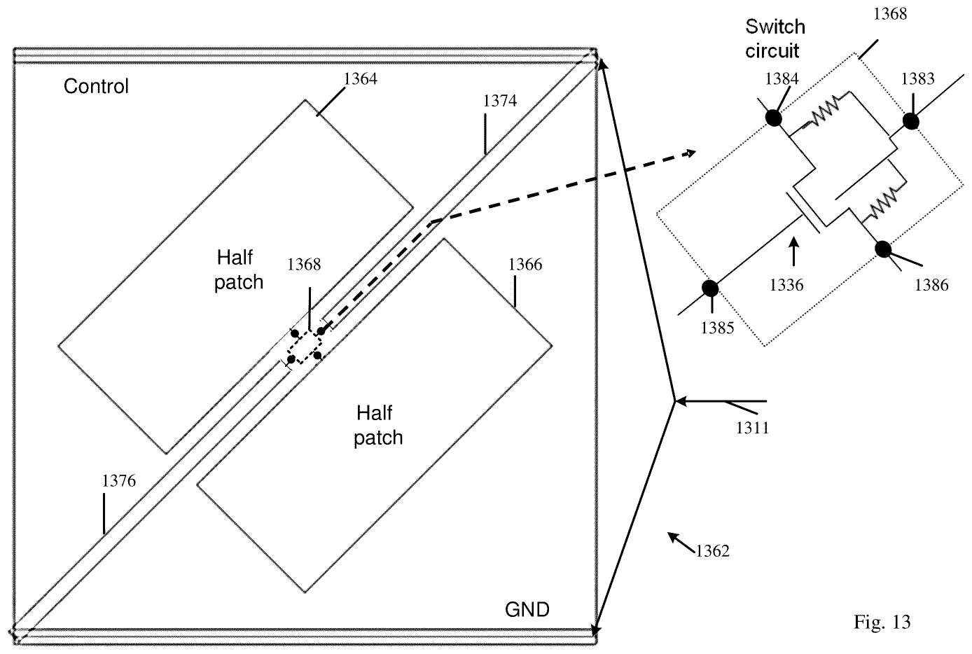

Reference is made to FIG. 13, which schematically illustrates a switchable patch 1362, in accordance with some demonstrative aspects. For example, switchable patch 1062 (FIG. 10) may include one or more elements of switchable patch 1362, and/or may perform one or more operations and/or functionalities of switchable patch 1362.

In some demonstrative aspects, as shown in FIG. 13, the switchable patch 1362 may include a first metal patch 1364.

In some demonstrative aspects, as shown in FIG. 13, the switchable patch 1362 may include a second metal patch 1366.

In some demonstrative aspects, the switchable patch 1362 may be switchable between a first patch configuration and a second patch configuration, for example, based on a control signal 1311.

For example, control signal 1311 may include control signal 1011 (FIG. 10). For example, controller 1050 (FIG. 1) may be configured to control switching of switchable patch 1362 between a first patch configuration and a second patch configuration, for example, according to a state to be configured for a polarization-rotator cell 1022 (FIG. 10) including the switchable patch 1362, e.g., as described above.

For example, switchable patch 1362 may be at the first patch configuration, for example, when the polarization-rotator cell 1022 (FIG. 10) is at the non-rotation state, e.g., as described above.

For example, switchable patch 1362 may be at the second patch configuration, for example, when the polarization-rotator cell 1022 (FIG. 10) is at the rotation state, e.g., as described above.

In some demonstrative aspects, the first patch configuration may include the first metal patch 1364 and the second metal patch 1366 electrically disconnected from one another, e.g., as described below.

In some demonstrative aspects, the second patch configuration may include an equivalent patch formed by electric connection between the first metal patch 1364 and the second metal patch 1366, e.g., as described below.

In some demonstrative aspects, as shown in FIG. 13, a configuration of switchable patch 1362 may be similar to a configuration of switchable patch 1162 (FIG. 11).

In some demonstrative aspects, the switching circuitry 1368 may be configured to implement a 4-Port switching scheme utilizing two control ports to couple switching circuitry 1368 to a control signal via two control lines, and two patch ports to couple the switching circuitry 1368 to the two metal patches 1364 and 1366.

In some demonstrative aspects, as shown in FIG. 13, the switching circuitry 1368 may include a first patch port 1384, which may be configured to connect the switching circuitry 1368 to the first metal patch 1364.

In some demonstrative aspects, as shown in FIG. 13, the switching circuitry 1368 may include a second patch port 1386, which may be configured to connect the switching circuitry 1368 to the second metal patch 1366.

In some demonstrative aspects, as shown in FIG. 13, the switching circuitry 1368 may include a first control port 1383, which may be configured to electrically connect the switching circuitry 1368 to a first control line 1374, for example, to electrically connect the switching circuitry 1368 to a first control port of an input to provide the control signal 1311, e.g., the first control port 1075 (FIG. 10).

In some demonstrative aspects, as shown in FIG. 13, the switching circuitry 1368 may include a second control port 1385, which may be configured to electrically connect the switching circuitry 1368 to a second control line 1376, for example, to electrically connect the switching circuitry 1368 to a second control port of an input to provide the control signal 1311, e.g., the second control port 1077 (FIG. 10).

In some demonstrative aspects, as shown in FIG. 13, the switching functionality of switching circuitry 1368 may be implemented, for example, utilizing one or more NMOS transistors 1336.

In other aspects, as shown in FIG. 13, the switching functionality of switching circuitry 1368 may be implemented, for example, utilizing one or more PMOS transistors, for example, instead of the one or more NMOS transistors 1336 (FIG. 11).

In some demonstrative aspects, as shown in FIG. 13, the first control line 1374 may include a signal control line to provide control signal 1311 to the switching circuitry 1368, e.g., via the first control port 1383.

In some demonstrative aspects, as shown in FIG. 13, the second control line 1376 may include a GND line to provide ground to the switching circuitry 1368, e.g., via the second control port 1385.

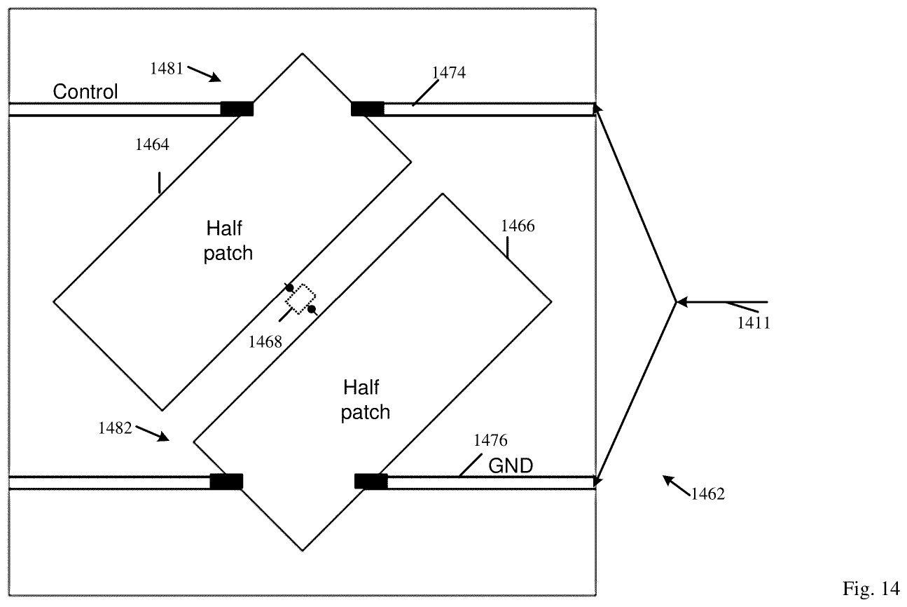

Reference is made to FIG. 14, which schematically illustrates a switchable patch 1462, in accordance with some demonstrative aspects. For example, switchable patch 1062 (FIG. 10) may include one or more elements of switchable patch 1462, and/or may perform one or more operations and/or functionalities of switchable patch 1462.

In some demonstrative aspects, as shown in FIG. 14, the switchable patch 1462 may include a first metal patch 1464.

In some demonstrative aspects, as shown in FIG. 14, the switchable patch 1462 may include a second metal patch 1466.

In some demonstrative aspects, the switchable patch 1462 may be switchable between a first patch configuration and a second patch configuration, for example, based on a control signal 1411.

For example, control signal 1411 may include control signal 1011 (FIG. 10). For example, controller 1050 (FIG. 1) may be configured to control switching of switchable patch 1462 between a first patch configuration and a second patch configuration, for example, according to a state to be configured for a polarization-rotator cell 1022 (FIG. 10) including the switchable patch 1462, e.g., as described above.

For example, switchable patch 1462 may be at the first patch configuration, for example, when the polarization-rotator cell 1022 (FIG. 10) is at the non-rotation state, e.g., as described above.

For example, switchable patch 1462 may be at the second patch configuration, for example, when the polarization-rotator cell 1022 (FIG. 10) is at the rotation state, e.g., as described above.

In some demonstrative aspects, the first patch configuration may include the first metal patch 1464 and the second metal patch 1466 electrically disconnected from one another, e.g., as described below.

In some demonstrative aspects, the second patch configuration may include an equivalent patch formed by electric connection between the first metal patch 1464 and the second metal patch 1466, e.g., as described below.

In some demonstrative aspects, as shown in FIG. 14, the first metal patch 1464 may be connected to a first control line 1474, for example, to electrically connect the first metal patch 1464 to a first control port of an input to provide the control signal 1411, e.g., the first control port 1075 (FIG. 10).

In some demonstrative aspects, as shown in FIG. 14, the second metal patch 1466 may be connected to a second control line 1476, for example, to electrically connect the second metal patch 1466 to a second control port of an input to provide the control signal 1411, e.g., the second control port 1077 (FIG. 10).

In some demonstrative aspects, as shown in FIG. 14, a configuration of switchable patch 1462 may be similar to a configuration of switchable patch 1162 (FIG. 11).

In some demonstrative aspects, as shown in FIG. 14, switchable patch 1462 may include one or more first resistors 1481 connected between the first metal patch 1464 and the first control line 1474.

In some demonstrative aspects, as shown in FIG. 14, the switchable patch 1462 may include one or more second resistors 1482 connected between the second metal patch 1466 and the second control line 1476.

In some demonstrative aspects, the one or more first resistors 1481 and/or the one or more second resistors 1482 may be implemented, for example, to provide a technical solution to simplify a design of the switchable patch 1462 and/or to improve a patch response of the switchable patch 1462, for example, by reducing, e.g., preventing, RF current leakage from the first metal patch 1424 and/or the second metal patch 1426.

For example, a resistance of the one or more first resistors 1481 and/or the one or more second resistors 1482 may be configured, for example, such that the one or more first resistors 1481 and/or the one or more second resistors 1482 may perform the functionality of an RF choke.

In some demonstrative aspects, the switching circuitry 1468 may be configured to implement a 2-Port switching scheme utilizing two ports to couple the switching circuitry 1468 to the control signal 1411, for example, via the first metal patch 1464 and the second metal patch 1466, e.g., as described above.

In other aspects, the switching circuitry 1468 may be configured to implement a 4-Port switching scheme, e.g., as described above with reference to FIG. 13.

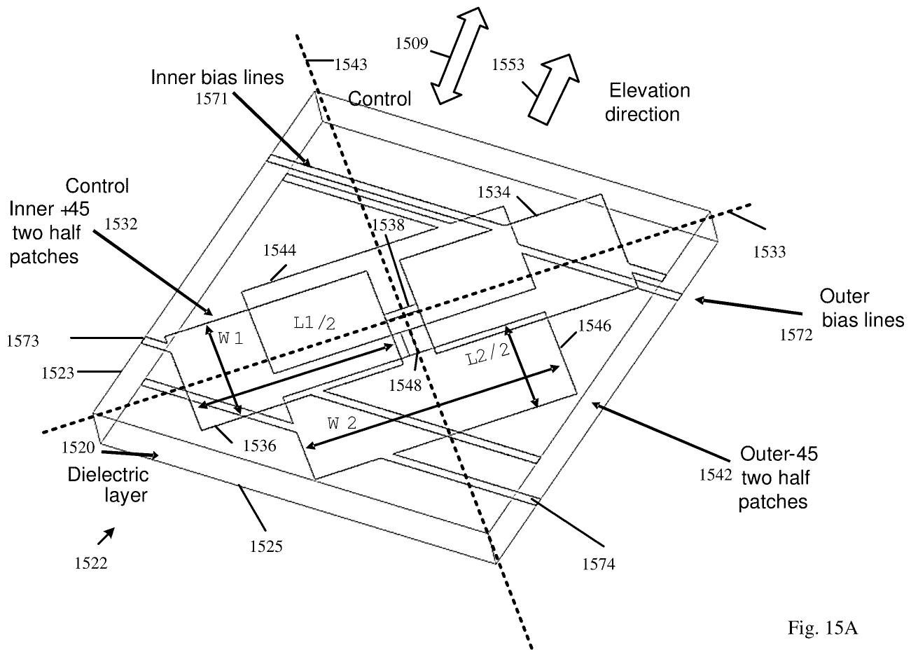

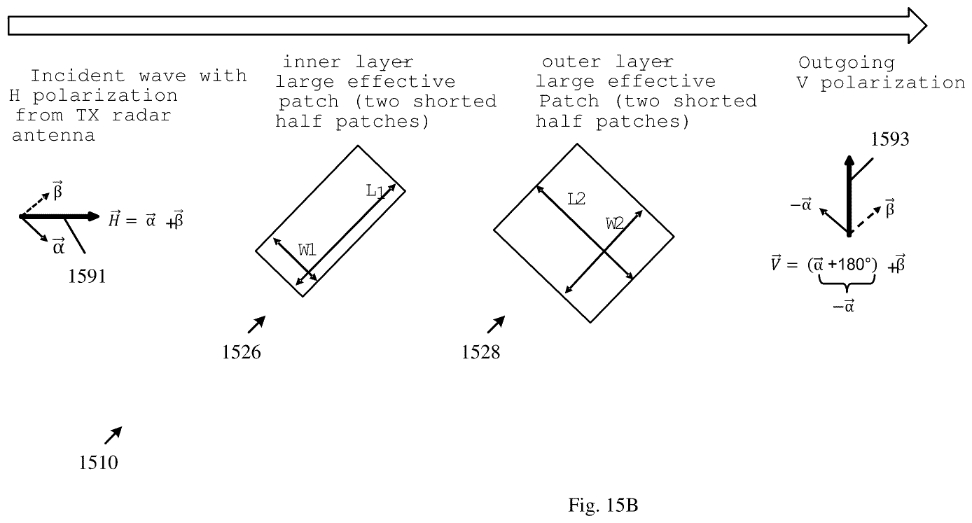

Reference is made to FIG. 15A, which schematically illustrates a polarization-rotator cell 1522, in accordance with some demonstrative aspects. For example, polarization-rotator cell 1022 (FIG. 10) may include one or more elements of switchable a polarization-rotator cell 1522, and/or may perform one or more operations and/or functionalities of a polarization-rotator cell 1522.

In some demonstrative aspects, polarization-rotator cell 1522 may be configured to apply a predefined polarization rotation to RF signals 1509, e.g., the RF signals 1009 (FIG. 10), to be communicated with a predefined polarization 1553, e.g., a horizontal polarization in an elevation direction.

In some demonstrative aspects, as shown in FIG. 15A, polarization-rotator cell 1522 may include a dielectric layer 1520.

In some demonstrative aspects, as shown in FIG. 15A, polarization-rotator cell 1522 may include a pair of switchable patches including a first switchable patch 1532 and a second switchable patch 1542.

In some demonstrative aspects, as shown in FIG. 15A, the first switchable patch 1532 may be on a first surface 1523, e.g., an “inner” surface facing an antenna (not shown in FIG. 15A) of the dielectric layer 1520.

In some demonstrative aspects, as shown in FIG. 15A, the second switchable patch 1542 may be on a second surface 1525, e.g., an “outer” surface facing a radome (not shown in FIG. 15A), of the dielectric layer 1520, which may be opposite to the first surface 1523.

In some demonstrative aspects, as shown in FIG. 15A, the first switchable patch 1532 may be different from the second switchable patch 1542.

In some demonstrative aspects, as shown in FIG. 15A, the first switchable patch 1532 may partially overlap with the second switchable patch 1542.

In some demonstrative aspects, as shown in FIG. 15A, the first switchable patch 1532 may include a first-switch first metal patch 1534 and a first-switch second metal patch 1536.

In some demonstrative aspects, as shown in FIG. 15A, the first-switch first metal patch 1534 and the first-switch second metal patch 1536 may be positioned side by side along a first common axis 1533.

In some demonstrative aspects, as shown in FIG. 15A, the second switchable patch 1542 may include a second-switch first metal patch 1544 and a second-switch second metal patch 1546.

In some demonstrative aspects, as shown in FIG. 15A, the second-switch first metal patch 1544 and the second-switch second metal patch 1546 may be positioned side by side along a second common axis 1543.

In some demonstrative aspects, as shown in FIG. 15A, the second common axis 1543 may be rotated with respect to the first common axis 1533.

In some demonstrative aspects, an axis-rotation angle between the first common axis 1533 and the second common axis 1543 may be based, for example, on the predefined polarization rotation to be applied by polarization-rotator cell 1522.

In some demonstrative aspects, as shown in FIG. 15A, the axis-rotation angle between the first common axis 1533 and the second common axis 1543 may be substantially 90 degrees.

In other aspects, any other suitable axis-rotation angle may be implemented.

In some demonstrative aspects, as shown in FIG. 15A, the first common axis 1533 may be rotated by substantially 45 degrees with respect to the polarization direction 1553 of the polarization of the RF signals 1509, e.g., the elevation direction.

In some demonstrative aspects, as shown in FIG. 15A, the second common axis 1543 may be rotated by substantially (−45) degrees with respect to the polarization direction 1553 of the polarization of the RF signals 1509.

In some demonstrative aspects, as shown in FIG. 15A, the first-switch first metal patch 1534 and the first-switch second metal patch 1536 may be substantially identical.

In some demonstrative aspects, as shown in FIG. 15A, each of the first-switch first metal patch 1534 and the first-switch second metal patch 1536 may include a substantially rectangular metal patch.

In some demonstrative aspects, as shown in FIG. 15A, the second-switch first metal patch 1544 and the second-switch second metal patch 1546 may be substantially identical.

In some demonstrative aspects, as shown in FIG. 15A, each of the second-switch first metal patch 1544 and the second-switch second metal patch 1546 may include a substantially rectangular metal patch.

In some demonstrative aspects, each of the first-switch first metal patch 1534 and the first-switch second metal patch 1536 may be configured to have a length, denoted L1/2, in a direction along the first common axis 1533, which may be no more than 30% of a wavelength of the RF signals 1509 to be communicated via the polarization-rotator cell 1522. For example, each of the first-switch first metal patch 1534 and the first-switch second metal patch 1536 may be configured to have a width, denoted W1.

In some demonstrative aspects, each of the second-switch first metal patch 1544 and the second-switch second metal patch 1546 may be configured to have a length, denoted L2/2, in a direction along the second common axis 1543, which may be no more than 30% of a wavelength of the RF signals 1509 to be communicated via the polarization-rotator cell 1522. For example, each of the second-switch first metal patch 1544 and the second-switch second metal patch 1546 may be configured to have a width, denoted W2.

In some demonstrative aspects, as shown in FIG. 15A, the first switchable patch 1532 may include switching circuitry 1538 between the first-switch first metal patch 1534 and the first-switch second metal patch 1536.

In some demonstrative aspects, switching circuitry 1538 may be configured to electrically disconnect between the first-switch first metal patch 1534 and the first-switch second metal patch 1536, for example, at a no-rotation state of polarization-rotator cell 1522, e.g., as described above.

In some demonstrative aspects, switching circuitry 1538 may be configured to electrically connect between the first-switch first metal patch 1534 and the first-switch second metal patch 1536, for example, a rotation state of polarization-rotator cell 1522, e.g., as described above.

In some demonstrative aspects, as shown in FIG. 15A, the second switchable patch 1542 may include switching circuitry 1548 between the second-switch first metal patch 1544 and the second-switch second metal patch 1546.

In some demonstrative aspects, switching circuitry 1548 may be configured to electrically disconnect between the second-switch first metal patch 1544 and the second-switch second metal patch 1546, for example, at the no-rotation state of polarization-rotator cell 1522, e.g., as described above.

In some demonstrative aspects, switching circuitry 1548 may be configured to electrically connect between the second-switch first metal patch 1544 and the second-switch second metal patch 1546, for example, at the rotation state of polarization-rotator cell 1522, e.g., as described above.

In some demonstrative aspects, as shown in FIG. 15A, the first switchable patch 1532 and/or the second switchable patch 1542 may be implemented according to a 2-port switching scheme, e.g., as described above.

In other aspects, the first switchable patch 1532 and/or the second switchable patch 1542 may be implemented according to a 4-port switching scheme, e.g., as described above.

In some demonstrative aspects, the first-switch first metal patch 1534 may be connected to a first control (bias) line 1571, for example, to electrically connect the first-switch first metal patch 1534 to a first control port, e.g., first control port 1075 (FIG. 10) of input 1012 (FIG. 10).

In some demonstrative aspects, the second-switch first metal patch 1544 may be connected to a second control (bias) line 1572, for example, to electrically connect the second-switch first metal patch 1544 to the first control port, e.g., first control port 1075 (FIG. 10) of input 1012 (FIG. 10).

In some demonstrative aspects, the first-switch second metal patch 1536 may be connected to a third control line 1573, for example, to electrically connect the first-switch second metal patch 1534 to a second control port, e.g., second control port 1077 (FIG. 10) of input 1012 (FIG. 10).

In some demonstrative aspects, the second-switch second metal patch 1546 may be connected to a fourth control line 1574, for example, to electrically connect the second-switch second metal patch 1546 to the second control port, e.g., second control port 1077 (FIG. 10) of input 1012 (FIG. 10).

In some demonstrative aspects, a first voltage level e.g., a zero voltage, may be applied to the first switchable patch 1532, e.g., via the pair of control lines 1571 and 1573, and to the second switchable patch 1542, e.g., via the pair of control lines 1572 and 1574, for example, at the no-rotation (“OFF”) state of the polarization-rotator cell 1522. For example, switching circuitry 1538 may induce a first, e.g., relatively high, impedance between the first-switch first metal patch 1534 and the first-switch second metal patch 1536, and switching circuitry 1548 may induce a first, e.g., relatively high, impedance between the second-switch first metal patch 1544 and the second-switch second metal patch 1546. For example, switching circuitry 1538 may be configured such that the first impedance may cause the first-switch first metal patch 1534 and the first-switch second metal patch 1536 to be electrically disconnected, and switching circuitry 1548 may be configured such that the first impedance may cause the second-switch first metal patch 1544 and the second-switch second metal patch 1546 to be electrically disconnected.

In some demonstrative aspects, the metal patches of the polarization-rotator cell 1522, e.g., the first-switch first metal patch 1534, the first-switch second metal patch 1536, the second-switch first metal patch 1544, and/or the second-switch second metal patch 1546, may be configured, for example, such that the metal patches of the polarization-rotator cell 1522 may be substantially “transparent” to the RF signals 1509, for example, at the no-rotation (“OFF”) state of the polarization-rotator cell 1522. For example, the lengths L1/2 and L2/2 may be configured to be sufficiently smaller than the wavelength of the RF signals 1509, for example, such that a resonance frequency of the metal patches of the polarization-rotator cell 1522 may be substantially higher than, e.g., far above, the wavelength of the RF signals 1509. As a result, the metal patches of the polarization-rotator cell 1522 may be substantially “transparent” to the RF signals 1509, for example, such that the polarization direction 1553 of the RF signals 1509 may remain substantially unchanged.

In some demonstrative aspects, a second voltage level e.g., a VDD voltage, may be applied to the first switchable patch 1532, e.g., via the pair of control lines 1571 and 1573, and to the second switchable patch 1542, e.g., via the pair of control lines 1572 and 1574, for example, at the rotation (“ON”) state of the polarization-rotator cell 1522. For example, switching circuitry 1538 may induce a second, e.g., relatively low, impedance between the first-switch first metal patch 1534 and the first-switch second metal patch 1536, and switching circuitry 1548 may induce a low, e.g., relatively low, impedance between the second-switch first metal patch 1544 and the second-switch second metal patch 1546. For example, switching circuitry 1538 may be configured such that the second impedance may cause the first-switch first metal patch 1534 and the first-switch second metal patch 1536 to be electrically connected, and switching circuitry 1548 may be configured such that the second impedance may cause the second-switch first metal patch 1544 and the second-switch second metal patch 1546 to be electrically connected.

For example, the second, e.g., relatively low, impedance may be low, e.g., relatively low, compared to the first, e.g., relatively high, impedance.

In one example, the second impedance may be at least one order of magnitude lower than the first impedance.

In one example, the second impedance may be at least two orders of magnitude lower than the first impedance.

In other aspects, the first impedance and/or the second impedance may be configured according to any other suitable setting.

In some demonstrative aspects, switching circuitry 1538 may be configured to electrically connect the first-switch first metal patch 1534 and the first-switch second metal patch 1536, or example, to form a first equivalent patch, e.g., having a length L1 and a width W1, for example, at the rotation (“ON”) state of the polarization-rotator cell 1522.

In some demonstrative aspects, switching circuitry 1548 may be configured to electrically connect the second-switch first metal patch 1544 and the second-switch second metal patch 1546, or example, to form a second equivalent patch, e.g., having a length L2 and a width W2, for example, at the rotation (“ON”) state of the polarization-rotator cell 1522.

In some demonstrative aspects, the metal patches of the polarization-rotator cell 1522, e.g., the first-switch first metal patch 1534, the first-switch second metal patch 1536, the second-switch first metal patch 1544, and/or the second-switch second metal patch 1546, may be configured, for example, such that the metal patches of the polarization-rotator cell 1522 may be not be “transparent” to the RF signals 1509, for example, at the rotation (“ON”) state of the polarization-rotator cell 1522. For example, the lengths L1 and L2 may be configured to be substantially in the order of, e.g., equal to or greater than, the wavelength of the RF signals 1509, for example, such that a resonance frequency of the metal patches of the polarization-rotator cell 1522 may be substantially similar to the wavelength of the RF signals 1509. As a result, the metal patches of the polarization-rotator cell 1522 may not be “transparent” to the RF signals 1509, for example, such that the polarization direction 1553 of the RF signals 1509 may be changed.

Reference is made to FIG. 15B, which schematically illustrates a polarization rotation scheme 1510 to rotate the polarization of the RF signal 1509 to be communicated via the polarization-rotator cell 1522, in accordance with some demonstrative aspects.

In some demonstrative aspects, as shown in FIG. 15B, the first-switch first metal patch 1534 (FIG. 15A) and the first-switch second metal patch 1536 (FIG. 15A) may be electrically connected by switching circuitry 1538 (FIG. 15A), for example, to form a first equivalent patch 1526, e.g., in the form of a large rectangular patch having a size of W1*L1, for example, at the rotation (“ON”) state of the polarization-rotator cell 1522 (FIG. 15A).

In some demonstrative aspects, as shown in FIG. 15B, the second-switch first metal patch 1544 (FIG. 15A) and the second-switch second metal patch 1546 (FIG. 15A) may be electrically connected by switching circuitry 1548 (FIG. 15A), for example, to form a second equivalent patch 1528, e.g., in the form of a large rectangular patch having a size of W2*L2, for example, at the rotation (“ON”) state of the polarization-rotator cell 1522 (FIG. 15A).

In some demonstrative aspects, the metal patches of the polarization-rotator cell 1522, e.g., the first-switch first metal patch 1534, the first-switch second metal patch 1536, the second-switch first metal patch 1544, and/or the second-switch second metal patch 1546, may be configured, for example, such that the first large rectangular patch 1526 and the second large rectangular patch 1528 may resonate at the wavelength of the RF signals 1509. For example, the length L1 and the length L2 may be configured to be substantially in the order of the wavelength of the RF signal 1509. For example, the metal patches of the polarization-rotator cell 1522, e.g., the first-switch first metal patch 1534, the first-switch second metal patch 1536, the second-switch first metal patch 1544, and/or the second-switch second metal patch 1546, may be configured, such that the first large rectangular patch 1526 and the second large rectangular patch 1528 may not be “transparent” to the communicated RF signals 1509. For example, the metal patches of the polarization-rotator cell 1522 may be configured such that the first large rectangular patch 1526 and the second large rectangular patch 1528 may apply a predefined polarization rotation to the polarization direction 1553 of the RF signals 1509.

In one example, polarization rotation scheme 1510 may demonstrate a conversion process of polarization-rotator cell 1522, for example, to apply a 90-degree polarization rotation to the RF signals 1509 communicated via polarization-rotator cell 1522, for example, to rotate a horizontal polarization of RF signals 1509 into a vertical polarization, or vice-versa.

In other aspects, polarization-rotator cell 1522 may be configured to apply any other suitable polarization rotation to the RF signals 1509.

In some demonstrative aspects, as shown in FIG. 15B, an H-polarization 1591 of the RF signals 1509 may be decomposed into a first diagonal component (α) and a second diagonal component (β).

IN some demonstrative aspects, as shown in FIG. 15B, polarization-rotator cell 1522 may be configured to apply a phase difference, e.g., of 180 degrees to the diagonal component α of the H-polarization 1591.

In some demonstrative aspects, this phase difference may be created, for example, by differences in lengths between the dimensions of the first large rectangular patch 1526 and the second large rectangular patch 1528.

In some demonstrative aspects, for example, the dimensions L1 and W1 of the first large rectangular patch 1526 and/or the dimensions L2 and W2 of the second large rectangular patch 1528 may be configured, for example, such that a phase of about 180 degrees is to be added to the first diagonal component α, while substantially no phase may be added to the second diagonal component β, for example, to result in a Vertical polarization (\vec{V}) 1593, e.g., as follows:

$$\vec{V} = ( \vec{α} + 180 ° ) + \vec{β} , \vec{α} + 180 ° = - \vec{α}$$

In some demonstrative aspects, polarization-rotator cell 1522 may be configured to rotate, e.g., in a similar manner, a V-polarization 1593 into an H-polarization 1591, for example, for RF signals applied to the polarization-rotator cell 1522 in an opposite direction, e.g., from the surface 1525 towards the surface 1523.

In one example, polarization-rotator cell 1522 may be positioned such that the surface 1523 is facing an array of antennas, e.g., Tx antennas and Rx antennas, of a radar device, e.g., as described above. According to this example, polarization-rotator cell 1522 may be configured to rotate a polarization of Tx signals transmitted from the Tx antennas, for example, from an H-polarization 1591 to a V-polarization 1593. For example, polarization-rotator cell 1522 may be configured to rotate a polarization of Rx signals, which may be reflected from one or more targets, for example, from the V-polarization 1593 back to the H-polarization 1591 to be provided to the Rx antennas.

In some demonstrative aspects, polarization-rotator cell 1522 may be configured to support any other suitable polarization rotation to be applied between any other two polarizations, for example, north-west to south-east diagonal, right hand to left hand circular, or the like. For example, the dimensions L1, W1, L2 and/or W2 may be configured based on the magnitude of the polarization rotation to be applied by polarization-rotator cell 1522.

In some demonstrative aspects, polarization-rotator cell 1522 may be configured to support any other phase relations between the first diagonal component α and the second diagonal component β. For example, separate controls may be applied to the “inner layer” switchable patch 1532 and the “outer layer” switchable patch 1542. In one example, one of the switchable patch 1532 and the switchable patch 1542 may be activated, e.g., while another one of the switchable patches 1532 and 1542 may remain inactive, for example, support a polarization conversion between a linear polarization and a circular polarization, or vice versa.

In some demonstrative aspects, polarization-rotator cell 1522 may be configured to utilize two layers of switchable patches, for example, a first layer including the switchable patch 1532 and a second layer including the switchable patch 1542, e.g., as described above.

In some demonstrative aspects, polarization-rotator cell 1522 may be configured to utilize more than two layers of switchable patches. For example, polarization-rotator cell 1522 may be configured to include at least one additional layer including at least one additional switchable patch (not shown in FIG. 15A), for example, over layer 1525.

In some demonstrative aspects, polarization-rotator cell 1522 may be configured to include three or more layers of switchable patches, for example, to provide technical solution to support a plurality of polarization rotations, e.g., at the “ON” state.

For example, polarization-rotator cell 1522 may include three or more layers of switchable patches.

In one example, polarization-rotator cell 1522 may be configured to activate a first plurality of layers of switchable patches, e.g., a first layer of switchable patches and a second layer of switchable patches, for example, to apply a first polarization rotation.

In another example, polarization-rotator cell 1522 may be configured to activate a second plurality of layers of switchable patches, e.g., the first layer of switchable patches and a third layer of switchable patches, for example, to apply a second polarization rotation, e.g., different from the first polarization rotation.

In another example, polarization-rotator cell 1522 may be configured to activate a third plurality of layers of switchable patches, e.g., the second layer of switchable patches and a third layer of switchable patches, for example, to apply a third polarization rotation, e.g., different from the first and second polarization rotations.

In some demonstrative aspects, polarization-rotator cell 1522 may be configured to include three or more layers of switchable patches, for example, to provide technical solution to support the polarization rotation over an increased frequency bandwidth, e.g., at the “ON” state.

In some demonstrative aspects, polarization-rotator cell 1522 may be configured to include three or more layers of switchable patches, for example, to provide technical solution to support improved “transparency” properties of the polarization-rotator cell 1522, e.g., at the “OFF” state. For example, an increased number of layers of switchable patches may be implemented to increase the accuracy of the “transparency” properties of the polarization-rotator cell 1522, e.g., at the “OFF” state.

Referring back to FIG. 10, in some demonstrative aspects, switchable patch 1062 may include the plurality of metal patches 1071 including two metal patches, for example, metal patch 1064 and metal patch 1066, e.g., as described above.

In some demonstrative aspects, a switchable patch 1062 may include the plurality of metal patches 1071 including more than two metal patches, e.g., three or more metal patches, e.g., as described below.

In some demonstrative aspects, the plurality of metal patches 1071 may include a third metal patch (not shown in FIG. 10), for example, in addition to the first metal patch 1064 and the second metal patch 1066, e.g., as described below.

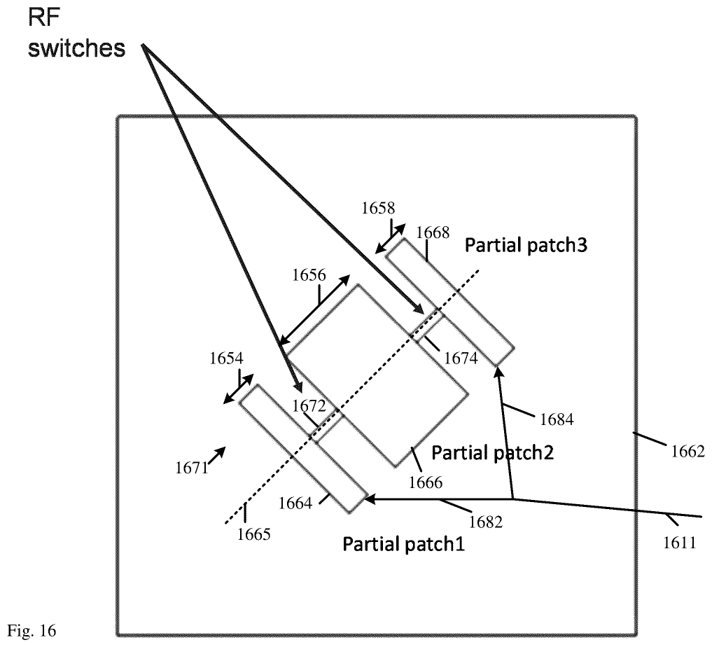

Reference is made to FIG. 16, which schematically illustrates a switchable patch 1662, in accordance with some demonstrative aspects. For example, switchable patch 1062 (FIG. 10) may include one or more elements of switchable patch 1662, and/or may perform one or more operations and/or functionalities of switchable patch 1662.

In some demonstrative aspects, as shown in FIG. 16, the switchable patch 1662 may include a plurality of metal patches 1671 including three metal patches, e.g., as described below.

In other aspects, the switchable patch 1662 may include more than three metal patches.

In some demonstrative aspects, as shown in FIG. 16, the switchable patch 1662 may include a first metal patch 1664, e.g., as described below.

In some demonstrative aspects, as shown in FIG. 16, the switchable patch 1662 may include a second metal patch 1666, e.g., as described below.

In some demonstrative aspects, as shown in FIG. 16, the switchable patch 1662 may include a third metal patch 1668, e.g., as described below.

In some demonstrative aspects, the switchable patch 1662 may be switchable between a first patch configuration and a second patch configuration, for example, based on a control signal 1611.

For example, control signal 1611 may include control signal 1011 (FIG. 10). For example, controller 1050 (FIG. 1) may be configured to control switching of switchable patch 1662 between a first patch configuration and a second patch configuration, for example, according to a state to be configured for a polarization-rotator cell 1022 (FIG. 10) including the switchable patch 1662, e.g., as described above.

For example, switchable patch 1662 may be at the first patch configuration, for example, when the polarization-rotator cell 1022 (FIG. 10) is at the non-rotation state, e.g., as described above.

For example, switchable patch 1662 may be at the second patch configuration, for example, when the polarization-rotator cell 1022 (FIG. 10) is at the rotation state, e.g., as described above.

In some demonstrative aspects, the first patch configuration may include the first metal patch 1664, the second metal patch 1666, and the third metal patch 1668 electrically disconnected from one another, e.g., as described below.

In some demonstrative aspects, the second patch configuration may include an equivalent patch formed by electric connection between the first metal patch 1664, the second metal patch 1666, and the third metal patch 1668, e.g., as described below.

In some demonstrative aspects, as shown in FIG. 16, the switchable patch 1662 may include first switching circuitry 1672, for example, between the first metal patch 1664 and the second metal patch 1666.

In some demonstrative aspects, as shown in FIG. 16, the first switching circuitry 1672 may be configured to electrically disconnect between the second metal patch 1666 and the first metal patch 1664, for example, at the first patch configuration of the switchable patch 1662, for example, when the polarization-rotator cell 1022 (FIG. 10) is at the no-rotation state, e.g., as described above.

In some demonstrative aspects, as shown in FIG. 16, the first switching circuitry 1672 may be configured to electrically connect between the second metal patch 1666 and the first metal patch 1664, for example, at the second patch configuration of the switchable patch 1662, for example, when the polarization-rotator cell 1022 (FIG. 10) is at the rotation state, e.g., as described above.

In some demonstrative aspects, as shown in FIG. 16, the first switching circuitry 1672 may be configured to induce a first impedance between the second metal patch 1666 and the first metal patch 1664, for example, at the no-rotation state.

In some demonstrative aspects, as shown in FIG. 16, the first switching circuitry 1672 may be configured to induce a second impedance between the second metal patch 1666 and the first metal patch 1664, for example, at the rotation state.

In some demonstrative aspects, the first impedance may be greater than the second impedance.

In some demonstrative aspects, as shown in FIG. 16, the switchable patch 1662 may include second switching circuitry 1674, for example, between the third metal patch 1668 and the second metal patch 1666.

In some demonstrative aspects, as shown in FIG. 16, the second switching circuitry 1674 may be configured to electrically disconnect between the second metal patch 1666 and the third metal patch 1668, for example, at the first patch configuration of the switchable patch 1662, for example, when the polarization-rotator cell 1022 (FIG. 10) is at the no-rotation state, e.g., as described above.

In some demonstrative aspects, as shown in FIG. 16, the second switching circuitry 1674 may be configured to electrically connect between the second metal patch 1666 and the third metal patch 1668, for example, at the second patch configuration of the switchable patch 1662, for example, when the polarization-rotator cell 1022 (FIG. 10) is at the rotation state, e.g., as described above.

In some demonstrative aspects, as shown in FIG. 16, the second switching circuitry 1674 may be configured to induce the first impedance between the second metal patch 1666 and the third metal patch 1668, for example, at the no-rotation state.

In some demonstrative aspects, as shown in FIG. 16, the second switching circuitry 1674 may be configured to induce the second impedance between the second metal patch 1666 and the third metal patch 1668, for example, at the rotation state.

In some demonstrative aspects, as shown in FIG. 16, the first metal patch 1664 may be connected to a first control line 1682, for example, to electrically connect the first metal patch 1664 to a first control port of an input to provide the control signal 1611, e.g., the first control port 1075 (FIG. 10).

In some demonstrative aspects, as shown in FIG. 16, the third metal patch 1668 may be connected to a second control line 1684, for example, to electrically connect the third metal patch 1668 to a second control port of an input to provide the control signal 1611, e.g., the second control port 1077 (FIG. 10).

In some demonstrative aspects, as shown in FIG. 16, the first metal patch 1664, the second metal patch 1666, and the third metal patch 1668 may be positioned side by side along a common axis 1665.

In some demonstrative aspects, a sum of lengths of the plurality of metal patches 1671 in a direction along the common axis 1665 may be equal to or greater than 40% of a wavelength of RF signals to be communicated via the switchable patch 1662.

For example, a sum of a length 1654 of the first metal patch 1664 in the direction along the common axis 1665, a length 1656 of the second metal patch 1666 in the direction along the common axis 1665, and a length 1658 of the third metal patch 1668 in the direction along the common axis 1665 may be equal to or greater than 40% of the wavelength of the RF signals.

In some demonstrative aspects, each of the length 1654, the length 1656, and the length 1658 may be no more than 30% of the wavelength of the RF signals.

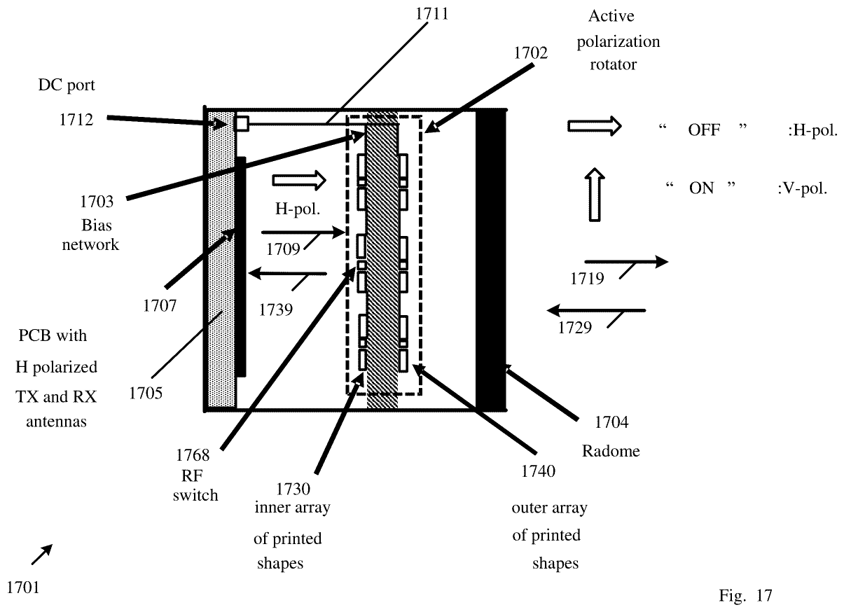

Reference is made to FIG. 17, which schematically illustrates a system 1701 including a polarization rotator 1702, in accordance with some demonstrative aspects. For example, system 1001 (FIG. 10) may include one or more elements of system 1701, and/or may perform one or more operations and/or functionalities of system 1701; and/or polarization rotator 1002 (FIG. 10) may include one or more elements of polarization rotator 1702, and/or may perform one or more operations and/or functionalities of polarization rotator 1702.

In some demonstrative aspects, one or more components of system 1701 may be implemented as part of a radar device. For example, radar device 800 (FIG. 8) may include one or more elements of system 1701, and/or may perform one or more operations and/or functionalities of system 1701.

In one example, system 1701 may demonstrate a side-view concept of a placement and a functionality of polarization rotator 1702.

In some demonstrative aspects, as shown in FIG. 17, system 1701 may include an antenna array 1707, for example, including one or more Tx antennas and one or more Rx antennas, which may be implemented, for example, on a suitable Printed Circuit Board (PCB) 1705.

In some demonstrative aspects, as shown in FIG. 17, system 1701 may include a radome 1704, which may be configured, for example, to cover the antenna array 1707.

In some demonstrative aspects, as shown in FIG. 17, the polarization rotator 1702 may be between the antenna array 1707 and the radome 1704.

In some demonstrative aspects, as shown in FIG. 17, the polarization rotator 1702 may include a dielectric layer 1720, e.g., as described above.

In some demonstrative aspects, as shown in FIG. 17, the polarization rotator 1702 may include a plurality of first switchable patches 1730 on a first surface, e.g., an “inner” surface, of the dielectric layer 1720, e.g., as described above.

In one example, the plurality of first switchable patches 1730 may include a first array of printed shapes, e.g., patches, on the first surface of the dielectric layer 1720, e.g., as described above.

In some demonstrative aspects, as shown in FIG. 17, the polarization rotator 1702 may include a plurality of second switchable patches 1740 on a second surface, e.g., an “outer” surface, of the dielectric layer 1720 opposite to the first surface, e.g., as described above.

In one example, the plurality of second switchable patches 1740 may include a second array of printed shapes, e.g., patches, on the second surface of the dielectric layer 1720, e.g., as described above.

In some demonstrative aspects, as shown in FIG. 17, the polarization rotator 1702 may include an input to receive a control signal 1711, e.g., from the PCB 1705.

In one example, the antenna array 1707 may include single-polarization antennas 1707 having a single-polarization, e.g., a horizontal polarization (H-POL).

For example, the polarization rotator 1702 may be configured to rotate a polarization of RF signals communicated by the single-polarization antennas 1707, for example, between the horizontal polarization and a vertical polarization (V-POL), for example, at the rotation state (“ON”) of the polarization rotator 1702, e.g., as described above.

For example, the polarization rotator 1702 may be configured to transfer the RF signals communicated by the single-polarization antennas 1707 with the horizontal polarization, for example, at the no-rotation state (“OFF”) of the polarization rotator 1702, e.g., as described above.

In some demonstrative aspects, the switchable patches of the polarization rotator 1702, e.g., the switchable patches 1730 and/or the switchable patches 1740, may be biased by control signal 1711, for example, by an external control, e.g., a DC port 1712, of the PCB 1705.

In one example, the external control may be configured to distribute the control signal 1711 to the switchable patches of the polarization rotator 1702, e.g., the switchable patches 1730 and/or the switchable patches 1740, for example, via a control (bias) network 1703.

In some demonstrative aspects, the polarization rotator 1702 may be configured to be at a no-rotation state, for example, when control signal 1711 includes a first voltage level, for example, when no voltage, e.g., a zero voltage, is applied by control signal 1711, e.g., as described above.

In some demonstrative aspects, the polarization rotator 1702 may be configured, for example, such that the switchable patches of the polarization rotator 1702, e.g., the switchable patches 1730 and/or the switchable patches 1740, are to be substantially “transparent” to the RF signals communicated by the antennas 1707, for example, when the polarization rotator 1702 is at the no-rotation state, e.g., as described above.

In some demonstrative aspects, the polarization rotator 1702 may be configured to maintain the original H-polarization of the RF signals communicated by antenna array 1707, e.g., substantially unchanged, for example, when the polarization rotator 1702 is at the no-rotation state, e.g., as described above.

In some demonstrative aspects, the polarization rotator 1702 may be configured to be at a rotation state, for example, when control signal 1711 includes a second voltage level, for example, when a VDD voltage is applied by control signal 1711, e.g., as described above.

In some demonstrative aspects, the polarization rotator 1702 may be configured, for example, such that the switchable patches of the polarization rotator 1702, e.g., the switchable patches 1730 and/or the switchable patches 1740, may not be “transparent” to the RF signals communicated by the antennas 1707, for example, when the polarization rotator 1702 is at the rotation state, e.g., as described above.

In some demonstrative aspects, the polarization rotator 1702 may be configured to change the original H-polarization of the RF signals communicated by antenna array 1707 by a predefined rotation, for example, to result in the V-polarization, for example, when the polarization rotator 1702 is at the rotation state, e.g., as described above.

In some demonstrative aspects, the polarization rotator 1702 may be configured to apply a phase difference to an H-polarized signal 1709 radiated by a Tx antenna, for example, to convert the H-polarized signal 1709 to a V-polarized signal 1719.

In some demonstrative aspects, the polarization rotator 1702 may be configured to rotate a V-polarized signal 1729, which may be reflected from a target, for example, from the V-polarization back to the H-polarization, for example, to provide an H-polarized signal 1739 to the Rx antennas of antenna array 1707.

In some demonstrative aspects, the polarization rotator 1702 may be configured to convert between an H-polarization of RF signals communicated at the antenna array 1707 and a V-polarization of RF signals communicated via the radome 1704, e.g., as described above.

In other aspects, the polarization rotator 1702 may be configured to convert between any other suitable types of polarizations.

In one example, the polarization rotator 1702 may be configured to convert between a V-polarization of RF signals communicated at the antenna array 1707 and an H-polarization of RF signals communicated via the radome 1704.

In another example, the polarization rotator 1702 may be configured to convert between a first diagonal polarization and a second diagonal polarization.

In another example, the polarization rotator 1702 may be configured to convert between a linear polarization and a circular polarization.

In another example, the polarization rotator 1702 may be configured to convert between a right hand circular polarization and a left hand circular polarization, or vice versa.

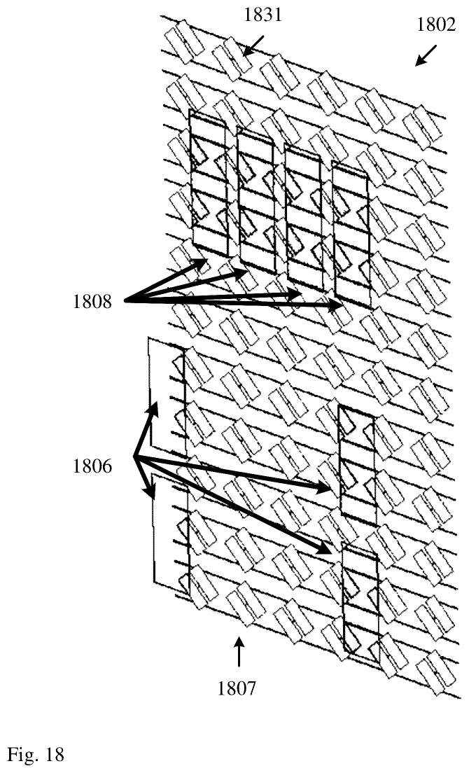

Reference is made to FIG. 18, which schematically illustrates a plurality of polarization-rotator cells 1831 of a polarization rotator 1802 configured to rotate a polarization of RF signals for an antenna array 1807, in accordance with some demonstrative aspects. For example, the plurality of polarization-rotator cells 1021 (FIG. 10) may include one or more elements of the plurality of polarization-rotator cells 1831.

In one example, the plurality of polarization-rotator cells 1831 may include the plurality of first switchable patches 1730 (FIG. 17) on the first surface of the dielectric layer 1720 (FIG. 17), which is facing the antenna array 1707 (FIG. 17), and the plurality of second switchable patches 1740 (FIG. 17) on the second surface of the dielectric layer 1720 (FIG. 17), which is facing the radome 1704 (FIG. 17).

In some demonstrative aspects, as shown in FIG. 18, antenna array 1807 may include a plurality of Tx antenna patches 1806, and a plurality of Rx antenna patches 1808.

In some demonstrative aspects, as shown in FIG. 18, the polarization rotator 1802 may be configured, for example, such that the plurality of polarization-rotator cells 1831 may substantially cover the antenna array 1807 including the plurality of Tx antenna patches 1806 and the plurality of Rx antenna patches 1808.

For example, shown in FIG. 18, the polarization rotator 1802 may be configured, for example, such that the plurality of polarization-rotator cells 1831 may be utilized to rotate the polarization of Tx signals transmitted by the plurality of Tx antenna patches 1806, e.g., from a first polarization to a second polarization, and to rotate the polarization of Rx signals from the second polarization back to the first polarization, e.g., to be received by plurality of Rx antenna patches 1808, e.g., as described above.

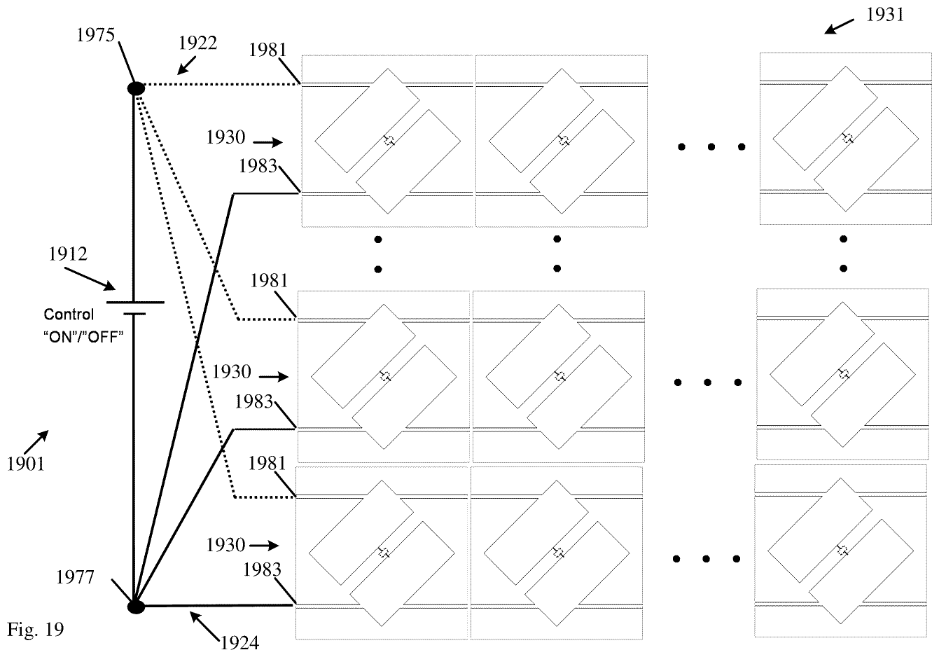

Reference is made to FIG. 19, which schematically illustrates a connection scheme 1901 to connect a plurality of switchable patches 1931 to an input 1912, in accordance with some demonstrative aspects. For example, the plurality of polarization-rotator cells 1021 (FIG. 10) may include one or more elements of the plurality of switchable patches 1931.

In some demonstrative aspects, the plurality of switchable patches 1931 may include an array of switchable patches on a layer of a polarization rotator, e.g., the polarization rotator 1702 (FIG. 17).

In one example, the plurality of switchable patches 1931 may include the plurality of first switchable patches 1730 (FIG. 17) on the first surface, e.g., the inner surface, of the dielectric layer 1720 (FIG. 17), which is facing the antenna array 1707 (FIG. 17).

In another example, the plurality of switchable patches 1931 may include the plurality of second switchable patches 1740 (FIG. 17) on the second surface, e.g., the outer surface, of the dielectric layer 1720 (FIG. 17), which is facing the radome 1704 (FIG. 17).

In some demonstrative aspects, as shown in FIG. 19, connection scheme 1901 may include a plurality of first control lines 1922, which may be configured to electrically connect a first port 1975 of the input 1912 to first ports 1981 of a plurality of subsets 1930 of the plurality of switchable patches 1931, respectively.

For example, as shown in FIG. 19, the plurality of subsets 1930 may include a respective plurality of rows of the array of switchable patches 1931.

For example, a control line 1922 may be configured to electrically connect the first port 1975 of the input 1912 to the first ports 1981 of a row of switchable patches 1931.

For example, the first port 1981 of a switchable patch 1931 may include a port to electrically connect a first metal patch of the switchable patch 1931 to the first port 1975 of the input 1912.

For example, the first port 1981 of the switchable patch 1931 may include a port to connect metal patch 1064 (FIG. 1) to the control line 1065 (FIG. 10)), e.g., as described above.

In some demonstrative aspects, as shown in FIG. 19, connection scheme 1901 may include a plurality of second control lines 1924, which may be configured to electrically connect a second port 1975 of the input 1912 to second ports 1983 of the plurality of subsets 1930 of the plurality of switchable patches 1931, respectively.

For example, a control line 1924 may be configured to electrically connect the second port 1977 of the input 1912 to the second ports 1983 of a row of switchable patches 1931.

For example, the second port 1983 of the switchable patch 1931 may include a port to electrically connect a second metal patch of the switchable patch 1931 to the second port 1977 of the input 1912.

For example, the second port 1981 of the switchable patch 1931 may include a port to connect metal patch 1066 (FIG. 1) to the control line 1067 (FIG. 10), e.g., as described above.

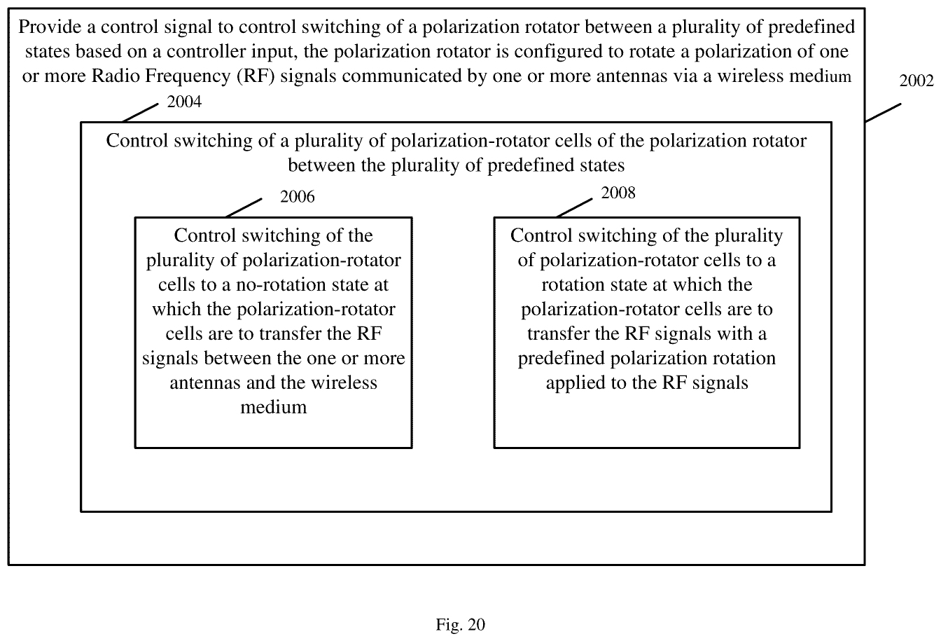

Reference is made to FIG. 20, which schematically illustrates a method of rotating a polarization of one or more RF signals, in accordance with some demonstrative aspects. For example, one or more of the operations of the method of FIG. 20 may be performed by a radar system, e.g., radar system 900 (FIG. 9); a radar device, e.g., radar device 800 (FIG. 8); a radar front-end, e.g., radar front-end 804 (FIG. 8); and/or a controller, e.g., controller 1050 (FIG. 10).

As indicated at block 2002, the method may include providing a control signal to control switching of a polarization rotator between a plurality of predefined states, for example, based on a controller input. For example, the polarization rotator may be configured to rotate a polarization of one or more RF signals communicated by one or more antennas via a wireless medium. For example, controller 1050 (FIG. 10) may be configured to provide the control signal 1011 (FIG. 10) to control the switching of the polarization rotator 1002 (FIG. 10) between the plurality of predefined states, for example, based on the controller input 1052 (FIG. 10), e.g., as described above.

As indicated at block 2004, providing the control signal to control the switching of the polarization rotator may include controlling switching of a plurality of polarization-rotator cells of the polarization rotator between the plurality of predefined states. For example, controller 1050 (FIG. 10) may provide the control signal 1011 (FIG. 10) to control the switching of the plurality of polarization-rotator cells 1021 (FIG. 10) between the plurality of predefined states, e.g., as described above.

As indicated at block 2006, controlling the switching of the plurality of polarization-rotator cells between the plurality of predefined states may include controlling switching of the plurality of polarization-rotator cells to a no-rotation state at which the polarization-rotator cells are to transfer the RF signals between the one or more antennas and the wireless medium. For example, controller 1050 (FIG. 10) may provide the control signal 1011 (FIG. 10) to control switching the plurality of polarization-rotator cells 1021 (FIG. 10) to the no-rotation state, at which the polarization-rotator cells 1021 (FIG. 10) are to transfer the RF signals 1009 (FIG. 10) between the one or more antennas 1007 (FIG. 10) and the wireless medium 1003 (FIG. 10), e.g., as described above.

As indicated at block 2008, controlling the switching of the plurality of polarization-rotator cells between the plurality of predefined states may include controlling switching of the plurality of polarization-rotator cells to a rotation state at which the polarization-rotator cells are to transfer the RF signals with a predefined polarization rotation applied to the RF signals. For example, controller 1050 (FIG. 10) may provide the control signal 1011 (FIG. 10) to control switching the plurality of polarization-rotator cells 1021 (FIG. 10) to the rotation state, at which the polarization-rotator cells 1021 (FIG. 10) are to transfer the RF signals 1009 (FIG. 10) with the predefined polarization rotation applied to the RF signals 1009 (FIG. 10), e.g., as described above.

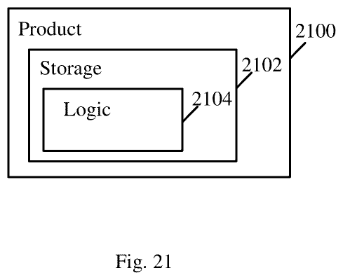

Reference is made to FIG. 21, which schematically illustrates a product of manufacture 2100, in accordance with some demonstrative aspects. Product 2100 may include one or more tangible computer-readable (“machine-readable”) non-transitory storage media 2102, which may include computer-executable instructions, e.g., implemented by logic 2104, operable to, when executed by at least one computer processor, enable the at least one computer processor to implement one or more operations and/or functionalities described with reference to any of the FIGS. 1-20, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2100 and/or machine-readable storage media 2102 may include one or more types of computer-readable storage media capable of storing data, including volatile memory, non-volatile memory, removable or non-removable memory, erasable or non-erasable memory, writeable or re-writeable memory, and the like. For example, machine-readable storage media 2102 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2104 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2104 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a polarization rotator configured to rotate a polarization of one or more Radio Frequency (RF) signals communicated by one or more antennas via a wireless medium, the polarization rotator comprising an input to receive a control signal; and a plurality of polarization-rotator cells switchable between a plurality of predefined states based on the control signal, the plurality of predefined states comprising a no-rotation state and a rotation state, wherein the plurality of polarization-rotator cells are configured to transfer the RF signals between the one or more antennas and the wireless medium at the no-rotation state, and to transfer the RF signals with a predefined polarization rotation applied to the RF signals at the rotation state.

Example 2 includes the subject matter of Example 1, and optionally, wherein the polarization-rotator comprises a dielectric layer; a plurality of first switchable patches on a first surface of the dielectric layer; and a plurality of second switchable patches on a second surface of the dielectric layer opposite to the first surface, wherein a switchable patch of the plurality of first switchable patches or the plurality of second switchable patches is switchable between a first patch configuration and a second patch configuration based on the control signal, wherein a polarization-rotator cell of the plurality of polarization rotator cells comprises a pair of switchable patches comprising a first switchable patch of the plurality of first switchable patches and a second switchable patch of the plurality of second switchable patches.

Example 3 includes the subject matter of Example 2, and optionally, wherein the first patch configuration comprises a plurality of patches, which are electrically disconnected from one another, wherein the second patch configuration comprises an equivalent patch formed by electric connections between the plurality of patches.

Example 4 includes the subject matter of Example 2 or 3, and optionally, wherein the switchable patch comprises a plurality of metal patches comprising a first metal patch and a second metal patch; and switching circuitry configured to electrically disconnect between the second metal patch and the first metal patch at the no-rotation state, and to electrically connect between the second metal patch and the first metal patch at the rotation state.

Example 5 includes the subject matter of Example 4, and optionally, wherein the first metal patch and the second metal patch are positioned side by side along a common axis.

Example 6 includes the subject matter of Example 5, and optionally, wherein the common axis is rotated by a predefined patch-rotation angle with respect to a polarization direction of the polarization of the RF signals.

Example 7 includes the subject matter of Example 6, and optionally, wherein the predefined patch-rotation angle is based on the predefined polarization rotation.

Example 8 includes the subject matter of Example 6 or 7, and optionally, wherein an absolute value of the predefined patch-rotation angle is substantially 45 degrees.

Example 9 includes the subject matter of any one of Examples 5-8, and optionally, wherein a length of each of the first metal patch and the second metal patch in a direction along the common axis is no more than 30% of a wavelength of the RF signals.

Example 10 includes the subject matter of Example 9, and optionally, wherein the length of each of the first metal patch and the second metal patch in the direction along the common axis is no more than 25% of the wavelength of the RF signals.

Example 11 includes the subject matter of any one of Examples 5-10, and optionally, wherein a length of each of the first metal patch and the second metal patch in a direction along the common axis is in a range between 20% of a wavelength of the RF signals and 30% of the wavelength of the RF signals.

Example 12 includes the subject matter of any one of Examples 5-11, and optionally, wherein a length of each of the first metal patch and the second metal patch in a direction along the common axis is substantially a quarter of a wavelength of the RF signals.

Example 13 includes the subject matter of any one of Examples 5-12, and optionally, wherein a sum of lengths of the plurality of metal patches in a direction along the common axis is equal to or greater than 40% of a wavelength of the RF signals.

Example 14 includes the subject matter of Example 13, and optionally, wherein the sum of the lengths of the plurality of metal patches is equal to or greater than 50% of the wavelength of the RF signals.

Example 15 includes the subject matter of Example 13 or 14, and optionally, wherein the sum of the lengths of the plurality of metal patches is in a range between 40% of a wavelength of the RF signals and 60% of the wavelength of the RF signals.

Example 16 includes the subject matter of any one of Examples 13-15, and optionally, wherein the sum of the lengths of the plurality of metal patches is substantially a half of a wavelength of the RF signals.

Example 17 includes the subject matter of any one of Examples 4-16, and optionally, wherein the first metal patch is connected to a first control line to electrically connect the first metal patch to a first control port of the input, wherein the second metal patch is connected to a second control line to electrically connect the second metal patch to a second control port of the input.

Example 18 includes the subject matter of Example 17, and optionally, wherein the switchable patch comprises one or more first resistors connected between the first metal patch and the first control line, and one or more second resistors connected between the second metal patch and the second control line.

Example 19 includes the subject matter of any one of Examples 4-16, and optionally, wherein the switching circuitry comprises a first patch port to connect the switching circuitry to the first metal patch, a second patch port to connect the switching circuitry to the second metal patch, a first control port to electrically connect the switching circuitry to a first control port of the input, and a second control port to electrically connect the switching circuitry to a second control port of the input.

Example 20 includes the subject matter of any one of Examples 4-19, and optionally, wherein the first metal patch comprises a first substantially rectangular metal patch, and the second metal patch comprises a second substantially rectangular metal patch.

Example 21 includes the subject matter of any one of Examples 4-20, and optionally, wherein the first metal patch and the second metal patch are substantially identical.

Example 22 includes the subject matter of any one of Examples 4-21, and optionally, wherein the switching circuitry is configured to induce a first impedance between the second metal patch and the first metal patch at the no-rotation state, and to induce a second impedance between the second metal patch and the first metal patch at the rotation state, the first impedance is greater than the second impedance.

Example 23 includes the subject matter of any one of Examples 4-22, and optionally, wherein the plurality of metal patches comprises a third metal patch, wherein the switching circuitry comprises first switching circuitry and second switching circuitry, wherein the first switching circuitry is configured to electrically disconnect between the second metal patch and the first metal patch at the no-rotation state, and to electrically connect between the second metal patch and the first metal patch at the rotation state, and wherein the second switching circuitry is configured to electrically disconnect between the third metal patch and the second metal patch at the no-rotation state, and to electrically connect between the third metal patch and the second metal patch at the rotation state.

Example 24 includes the subject matter of Example 23, and optionally, wherein the first switching circuitry is configured to induce a first impedance between the second metal patch and the first metal patch at the no-rotation state, and to induce a second impedance between the second metal patch and the first metal patch at the rotation state, wherein the second switching circuitry is configured to induce the first impedance between the third metal patch and the second metal patch at the no-rotation state, and to induce the second impedance between the third metal patch and the second metal patch at the rotation state, the first impedance is greater than the second impedance.

Example 25 includes the subject matter of Example 23 or 24, and optionally, wherein the first metal patch is connected to a first control line to electrically connect the first metal patch to a first control port of the input, wherein the third metal patch is connected to a second control line to electrically connect the third metal patch to a second control port of the input.

Example 26 includes the subject matter of any one of Examples 2-25, and optionally, wherein the first switchable patch comprises a first-switch first metal patch and a first-switch second metal patch positioned side by side along a first common axis, wherein the second switchable patch comprises a second-switch first metal patch and a second-switch second metal patch positioned side by side along a second common axis, wherein the second common axis is rotated with respect to the first common axis.

Example 27 includes the subject matter of Example 26, and optionally, wherein an axis-rotation angle between the first common axis and the second common axis is based on the predefined polarization rotation.

Example 28 includes the subject matter of Example 26 or 27, and optionally, wherein an axis-rotation angle between the first common axis and the second common axis is substantially 90 degrees.

Example 29 includes the subject matter of any one of Examples 2-28, and optionally, wherein the first switchable patch partially overlaps with the second switchable patch.

Example 30 includes the subject matter of any one of Examples 2-29, and optionally, wherein the first switchable patch is different from the second switchable patch.

Example 31 includes the subject matter of any one of Examples 2-30, and optionally, wherein the polarization rotator comprises a plurality of first control lines to electrically connect a first port of the input to a plurality of subsets of the plurality of first switchable patches, respectively, a plurality of second control lines to electrically connect the first port of the input to a plurality of subsets of the plurality of second switchable patches, respectively, a plurality of third control lines to electrically connect a second port of the input to the plurality of subsets of the plurality of first switchable patches, respectively, and a plurality of fourth control lines to electrically connect the second port of the input to the plurality of subsets of the plurality of second switchable patches, respectively.

Example 32 includes the subject matter of any one of Examples 1-31, and optionally, wherein the predefined polarization rotation comprises a polarization rotation of substantially 90 degrees.

Example 33 includes the subject matter of any one of Examples 1-32, and optionally, wherein the predefined polarization rotation is configured to rotate the polarization of the RF signals from a first linear polarization to a second linear polarization.

Example 34 includes the subject matter of any one of Examples 1-32, and optionally, wherein the predefined polarization rotation is configured to rotate the polarization of the RF signals from a first circular polarization to a second circular polarization.

Example 35 includes the subject matter of any one of Examples 1-32, and optionally, wherein the predefined polarization rotation is configured to rotate the polarization of the RF signals from one of a circular polarization or a linear polarization to another one of the circular polarization or the linear polarization.

Example 36 includes the subject matter of any one of Examples 1-35, and optionally, wherein the control signal comprises a Direct Current (DC) signal comprising a first voltage level at the no-rotation state, and a second voltage level at the rotation state, wherein the second voltage level is different from the first voltage level.

Example 37 includes the subject matter of Example 36, and optionally, wherein the first voltage level is substantially zero, and the second voltage level is based on a voltage supply level (VDD).

Example 38 includes the subject matter of any one of Examples 1-37, and optionally, wherein the polarization rotator is configured to rotate a Transmit (Tx) polarization of one or more Tx signals transmitted by one or more Tx antennas via the wireless medium.

Example 39 includes the subject matter of any one of Examples 1-38, and optionally, wherein the polarization rotator is configured to rotate a receive (Rx) polarization of one or more Rx signals to be received by one or more Rx antennas via the wireless medium.

Example 40 includes the subject matter of any one of Examples 1-39, and optionally, wherein the polarization rotator is configured to rotate the polarization of the one or more RF signals having a frequency above 70 Gigahertz (GHz).

Example 41 includes the subject matter of any one of Examples 1-40, and optionally, wherein the polarization rotator is configured to rotate the polarization of the one or more RF signals in a frequency band of 76-81 Gigahertz (GHz).

Example 42 includes the subject matter of any one of Examples 1-41, and optionally, comprising a controller configured to provide the control signal to the input.

Example 43 includes the subject matter of Example 42, and optionally, wherein the controller is configured to provide the control signal to control switching of the plurality of polarization-rotator cells between the plurality of predefined states based on a controller input.

Example 44 includes the subject matter of any one of Examples 1-43, and optionally, comprising a radar device comprising the one or more antennas, a radome, and the polarization rotator between the one or more antennas and the radome.

Example 45 includes the subject matter of any one of Examples 1-44, and optionally, comprising a radar device, the radar device comprising one or more Transmit (Tx) antennas to transmit one or more radar Tx signals with a first polarization, and one or more Receive (Rx) antennas to receive one or more radar Rx signals with the first polarization based on the one or more radar Tx signals, wherein the plurality of polarization-rotator cells are configured such that, at the rotation state, the plurality of polarization-rotator cells are to apply the predefined polarization rotation to the one or more radar Tx signals to rotate the first polarization of the one or more radar Tx signals to a second polarization; and apply the predefined polarization rotation to rotate a polarization of the one or more radar Rx signals from the second polarization to the first polarization.

Example 46 includes the subject matter of Example 45, and optionally, wherein the plurality of polarization-rotator cells are configured such that, at the no-rotation state, the plurality of polarization-rotator cells are to transfer the one or more radar Tx signals with the first polarization from the one or more Tx antennas to the wireless medium; and transfer the one or more Rx signals with the first polarization from the wireless medium to the one or more Rx antennas.

Example 47 includes the subject matter of any one of Examples 1-46, and optionally, comprising a radar device, the radar device comprising one or more Transmit (Tx) antennas, one or more Receive (Rx) antennas, and a processor to generate radar information based on one or more radar Rx signals received via the polarization rotator by the one or more Rx antennas based on one or more radar Tx signals transmitted by the one or more Tx antennas via the polarization rotator.

Example 48 includes the subject matter of Example 47, and optionally, comprising a vehicle, the vehicle comprising the radar device, and a system controller to control one or more systems of the vehicle based on the radar information.

Example 49 includes a device comprising the subject matter of any of Examples 1-48, and optionally, comprising the one or more antennas.

Example 50 includes the subject matter of Example 49, and optionally, comprising a communication interface to communicate the RF signals via the one or more antennas.

Example 51 includes a vehicle comprising the apparatus of any of Examples 1-50.

Example 52 includes an apparatus comprising means for performing any of the described operations of any of Examples 1-50.

Example 53 includes a machine-readable medium that stores instructions for execution by a processor to perform any of the described operations of any of Examples 1-50.

Example 54 comprises a product comprising one or more tangible computer-readable non-transitory storage media comprising computer-executable instructions operable to, when executed by at least one processor, enable the at least one processor to cause a device to perform any of the described operations of any of Examples 1-50.

Example 55 includes an apparatus comprising a memory; and processing circuitry configured to perform any of the described operations of any of Examples 1-50.

Example 56 includes a method including any of the described operations of any of Examples 1-50.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a polarization rotator configured to rotate a polarization of one or more Radio Frequency (RF) signals communicated by one or more antennas via a wireless medium, the polarization rotator comprising:
an input to receive a control signal; and
a plurality of polarization-rotator cells switchable between a plurality of predefined states based on the control signal, the plurality of predefined states comprising a no-rotation state and a rotation state, wherein the plurality of polarization-rotator cells are configured to transfer the RF signals between the one or more antennas and the wireless medium at the no-rotation state, and to transfer the RF signals with a predefined polarization rotation applied to the RF signals at the rotation state.

2. The apparatus of claim 1, wherein the polarization-rotator comprises:
a dielectric layer;
a plurality of first switchable patches on a first surface of the dielectric layer; and
a plurality of second switchable patches on a second surface of the dielectric layer opposite to the first surface,
wherein a switchable patch of the plurality of first switchable patches or the plurality of second switchable patches is switchable between a first patch configuration and a second patch configuration based on the control signal,
wherein a polarization-rotator cell of the plurality of polarization rotator cells comprises a pair of switchable patches comprising a first switchable patch of the plurality of first switchable patches and a second switchable patch of the plurality of second switchable patches.

3. The apparatus of claim 2, wherein the first patch configuration comprises a plurality of patches, which are electrically disconnected from one another, wherein the second patch configuration comprises an equivalent patch formed by electric connections between the plurality of patches.

4. The apparatus of claim 2, wherein the switchable patch comprises:
a plurality of metal patches comprising a first metal patch and a second metal patch; and
switching circuitry configured to electrically disconnect between the second metal patch and the first metal patch at the no-rotation state, and to electrically connect between the second metal patch and the first metal patch at the rotation state.

5. The apparatus of claim 4, wherein the first metal patch and the second metal patch are positioned side by side along a common axis.

6. The apparatus of claim 5, wherein the common axis is rotated by a predefined patch-rotation angle with respect to a polarization direction of the polarization of the RF signals.

7. The apparatus of claim 5, wherein a length of each of the first metal patch and the second metal patch in a direction along the common axis is no more than 30% of a wavelength of the RF signals.

8. The apparatus of claim 5, wherein a sum of lengths of the plurality of metal patches in a direction along the common axis is equal to or greater than 40% of a wavelength of the RF signals.

9. The apparatus of claim 4, wherein the first metal patch is connected to a first control line to electrically connect the first metal patch to a first control port of the input, wherein the second metal patch is connected to a second control line to electrically connect the second metal patch to a second control port of the input.

10. The apparatus of claim 9, wherein the switchable patch comprises one or more first resistors connected between the first metal patch and the first control line, and one or more second resistors connected between the second metal patch and the second control line.

11. The apparatus of claim 4, wherein the switching circuitry comprises a first patch port to connect the switching circuitry to the first metal patch, a second patch port to connect the switching circuitry to the second metal patch, a first control port to electrically connect the switching circuitry to a first control port of the input, and a second control port to electrically connect the switching circuitry to a second control port of the input.

12. The apparatus of claim 4, wherein the switching circuitry is configured to induce a first impedance between the second metal patch and the first metal patch at the no-rotation state, and to induce a second impedance between the second metal patch and the first metal patch at the rotation state, the first impedance is greater than the second impedance.

13. The apparatus of claim 4, wherein the plurality of metal patches comprises a third metal patch,
wherein the switching circuitry comprises first switching circuitry and second switching circuitry,
wherein the first switching circuitry is configured to electrically disconnect between the second metal patch and the first metal patch at the no-rotation state, and to electrically connect between the second metal patch and the first metal patch at the rotation state, and
wherein the second switching circuitry is configured to electrically disconnect between the third metal patch and the second metal patch at the no-rotation state, and to electrically connect between the third metal patch and the second metal patch at the rotation state.

14. The apparatus of claim 13, wherein the first metal patch is connected to a first control line to electrically connect the first metal patch to a first control port of the input, wherein the third metal patch is connected to a second control line to electrically connect the third metal patch to a second control port of the input.

15. The apparatus of claim 2, wherein the first switchable patch comprises a first-switch first metal patch and a first-switch second metal patch positioned side by side along a first common axis, wherein the second switchable patch comprises a second-switch first metal patch and a second-switch second metal patch positioned side by side along a second common axis, wherein the second common axis is rotated with respect to the first common axis.

16. The apparatus of claim 15, wherein an axis-rotation angle between the first common axis and the second common axis is based on the predefined polarization rotation.

17. The apparatus of claim 2, wherein the polarization rotator comprises a plurality of first control lines to electrically connect a first port of the input to a plurality of subsets of the plurality of first switchable patches, respectively, a plurality of second control lines to electrically connect the first port of the input to a plurality of subsets of the plurality of second switchable patches, respectively, a plurality of third control lines to electrically connect a second port of the input to the plurality of subsets of the plurality of first switchable patches, respectively, and a plurality of fourth control lines to electrically connect the second port of the input to the plurality of subsets of the plurality of second switchable patches, respectively.

18. The apparatus of claim 1, wherein the predefined polarization rotation comprises a polarization rotation of substantially 90 degrees.

19. The apparatus of claim 1, wherein the predefined polarization rotation is configured to rotate the polarization of the RF signals from a first linear polarization to a second linear polarization, from a first circular polarization to a second circular polarization, or from one of a circular polarization or a linear polarization to another one of the circular polarization or the linear polarization.

20. The apparatus of claim 1, wherein the control signal comprises a Direct Current (DC) signal comprising a first voltage level at the no-rotation state, and a second voltage level at the rotation state, wherein the second voltage level is different from the first voltage level.

21. The apparatus of claim 1, wherein the polarization rotator is configured to rotate the polarization of the one or more RF signals having a frequency above 70 Gigahertz (GHz).

22. The apparatus of claim 1 comprising a controller configured to provide the control signal to the input.

23. The apparatus of claim 22, wherein the controller is configured to provide the control signal to control switching of the plurality of polarization-rotator cells between the plurality of predefined states based on a controller input.

24. The apparatus of claim 1 comprising a radar device, the radar device comprising one or more Transmit (Tx) antennas to transmit one or more radar Tx signals with a first polarization, and one or more Receive (Rx) antennas to receive one or more radar Rx signals with the first polarization based on the one or more radar Tx signals, wherein the plurality of polarization-rotator cells are configured such that, at the rotation state, the plurality of polarization-rotator cells are to:
apply the predefined polarization rotation to the one or more radar Tx signals to rotate the first polarization of the one or more radar Tx signals to a second polarization; and
apply the predefined polarization rotation to rotate a polarization of the one or more radar Rx signals from the second polarization to the first polarization.

25. The apparatus of claim 1 comprising a radar device, the radar device comprising one or more Transmit (Tx) antennas, one or more Receive (Rx) antennas, and a processor to generate radar information based on one or more radar Rx signals received via the polarization rotator by the one or more Rx antennas based on one or more radar Tx signals transmitted by the one or more Tx antennas via the polarization rotator.
